(19) United States
(12) Patent Application Publication
(10) Pub. No.: US 2026/0040157 A1
(43) Pub. Date: Feb. 5, 2026

(54) Conditional Execution of L1/L2 Inter-Cell Mobility Serving Cell Change

(71) Applicant: Telefonaktiebolaget LM Ericsson (publ), Stockholm (SE)

(72) Inventors: Pontus Wallentin, Linköping (SE); Claes Tidestav, Bålsta (SE); Jens Bergqvist, Linköping (SE); Icaro Leonardo Da Silva, Solna (SE); Antonino Orsino, Kirkkonummi (FI)

(21) Appl. No.: 18/996,203

(22) PCT Filed: Aug. 8, 2023
(86) PCT No.: PCT/SE2023/050795

§ 371 Date: Jan. 17, 2025

Related U.S. Application Data
(60) Provisional application No. 63/396,018, filed on Aug. 8, 2022.

(51) Int. Cl. H04W 36/00; H04B 7/06

(52) U.S. Cl. CPC H04W 36/0061; H04B 7/06952

(57) ABSTRACT

Methods are described for a wireless device, such as a UE, to execute a Layer-1 (LI) or Layer-2 (L2) based inter-cell mobility serving cell change, based on the fulfillment of an execution condition (e.g., based on measurements), using a conditional reconfiguration. The UE receives, from a serving network node, a message containing at least one conditional reconfiguration for L1/L2 based inter-cell mobility serving cell change. The at least one conditional reconfiguration includes at least one of an execution condition, an indication of a candidate target cell for L1/L2 mobility, and a lower layer command. When an execution condition associated to the candidate target cell for L1/L2 inter-cell mobility is fulfilled, the UE executes the conditional reconfiguration that results in a L1/L2 based inter-cell mobility serving cell change to the candidate target cell. The UE then starts to operate according to a configuration of the candidate target cell in the L1/L2 based inter-cell mobility serving cell change.

### TECHNICAL FIELD

The present disclosure relates generally to wireless communication networks, in in particular to methods and apparatuses for conditional execution of L1/L2 based inter-cell mobility serving cell change.

### BACKGROUND

Wireless communication networks, including network nodes and radio network devices such as cellphones and smartphones, are ubiquitous in many parts of the world. These networks continue to grow in capacity and sophistication. To accommodate both more users and a wider range of types of devices that may benefit from wireless communications, the technical standards governing the operation of wireless communication networks continue to evolve. The fourth generation of network standards (4G, also known as Long Term Evolution, or LTE) has been deployed, the fifth generation (5G, also known as New Radio, or NR) is in development or the early stages of deployment, and the sixth generation (6G) is being planned.

Both LTE and NR networks follow a “cellular” architecture, wherein a plurality of generally fixed network nodes, known as base stations (also called eNB in LTE and gNB in NR) provide wireless communication services to both fixed and mobile radio network devices, referred to generally herein as User Equipment (UE), within a coverage area, or “cell.” The term cell also refers to the logical entity providing wireless communication service.

Mobility is a fundamental aspect of wireless communication networks. As a UE moves throughout a geographic region, it will move from one cell to another. The UE periodically performs measurements of the signal strength and quality of the air interface between it and a current serving cell, as well as neighboring cells. When a neighbor cell provides a consistently higher quality channel, the network performs a “handover” operation, passing control and servicing of the UE from the current, or “source” cell to the new, or “target” cell. Ideally, a handover is performed transparently to the user, who experiences no degradation in quality of any ongoing call as the handover is executed.

Handovers are normally triggered when the UE is at the cell edge and experiences poor radio conditions. If the UE enters poor radio conditions quickly, the conditions may already be so poor that the actual handover procedure may be hard to execute. If the uplink (UL) is already bad, it may lead to the condition that the network is not able to detect the measurement report transmitted by the UE, and hence cannot initiate the handover procedure. Downlink (DL) problems may lead to the situation that the handover command (i.e., the RRCReconfiguration message with a reconfigurationWithSync field) cannot successfully reach the UE. In poor radio conditions the DL message is more often segmented, which increases the risk of retransmissions, with an increased risk that the message doesn't reach the UE in time. Failed transmission of handover command is a common reason for unsuccessful handovers. Failed handovers result in the UE going Out of Service (OOS), requiring it to reconnect to the network, which requires extensive signaling. This depletes battery life of a mobile device, causes interference on the air interface, and degrades the user's perceived Quality of Service (QoS).

To improve mobility robustness and address the issues above, a concept known as conditional handover (CHO) is introduced in 3GPP Release 16. The key idea in CHO is that transmission and execution of the handover command are separated. This allows the handover command to be sent earlier to UE, when the radio conditions are still good, thus increasing the likelihood that the message is successfully transferred. The execution of the handover command is done at a later point in time, based on an associated execution condition. The execution condition is typically in the form a threshold, e.g., signal strength of candidate target cell becomes X dB better than the serving cell (a so-called A3 event) or signal strength of serving cell becomes worse than X dBm and signal strength of candidate target cell becomes better than Y dBm (a so-called A5 event).

As used herein, a cell for which conditional handover (or other conditional mobility procedure) is configured is denoted “candidate target cell” or “potential target cell”. Similarly, a radio network node controlling a candidate/potential target cell is denoted “candidate target node” or “potential target node.” In a sense, once the CHO execution condition has been fulfilled for a candidate/potential target cell, and CHO execution towards this candidate/potential target cell has been triggered, this cell is no longer “potential” or a “candidate” in the normal senses of the words, since it is no longer uncertain whether the CHO will be executed towards it. Hence, after the CHO execution condition has been fulfilled/triggered, the concerned candidate/potential target cell is herein sometimes referred to as simply a “target cell.”

Currently, CHO relies on Radio Resource Control (RRC) signaling, a high-level protocol. Latency, overhead, and interruption time may be reduced if CHO could be implemented with lower-level signaling. However, this must be done such that cell change is executed quickly, and that signaling overhead is reduced. Additionally, it would be advantageous to avoid the source cell connection being dropped because of a serving cell change (e.g., due to inter-cell mobility) that is triggered too late; or because a command from the network to trigger the serving cell change is not received by the UE due to poor radio conditions; or because of a Channel State Information (CSI) report (including measurements to support low-level signaling based inter-cell mobility) from the UE to trigger the execution of the serving cell change is not received by the network.

The Background section of this document is provided to place aspects of the present disclosure in technological and operational context, to assist those of skill in the art in understanding their scope and utility. Approaches described in the Background section could be pursued, but are not necessarily approaches that have been previously conceived or pursued. Unless explicitly identified as such, no statement herein is admitted to be prior art merely by its inclusion in the Background section

### SUMMARY

The following presents a simplified summary of the disclosure in order to provide a basic understanding to those of skill in the art. This summary is not an extensive overview of the disclosure and is not intended to identify key/critical elements of aspects of the disclosure or to delineate the scope of the disclosure. The sole purpose of this summary is to present some concepts disclosed herein in a simplified form as a prelude to the more detailed description that is presented later

According to aspects of the present disclosure described and claimed herein, methods for a UE to execute a Layer-1 (L1) or Layer-2 (L2) based inter-cell mobility serving cell change, based on the fulfillment of an execution condition (e.g., based on measurements), use a conditional reconfiguration. The UE receives, from a serving network node, a message containing at least one conditional reconfiguration for L1/L2 based inter-cell mobility serving cell change. The at least one conditional reconfiguration includes at least one of an execution condition, an indication of a candidate target cell for L1/L2 mobility, and a lower layer command. When an execution condition associated to the candidate target cell for L1/L2 inter-cell mobility is fulfilled, the UE executes the conditional reconfiguration that results in a L1/L2 based inter-cell mobility serving cell change to the candidate target cell. The UE then starts to operate according to a configuration of the candidate target cell in the L1/L2 based inter-cell mobility serving cell change.

Aspects of the disclosure also present methods for a serving network node, such as a serving gNB, a serving Distributed Unit (DU) or a serving Centralized Unit (CU), to configure and to control the execution of a L1/L2 based inter-cell mobility serving cell change for a UE based on the fulfillment of an execution condition (e.g., based on measurements) using a conditional reconfiguration. The serving network node may receive, from a target network node, a conditional reconfiguration for L1/L2 based inter-cell mobility serving cell change (e.g., in response to a request) and may transmit, to the UE, a message containing at least one conditional reconfiguration for L1/L2 based inter-cell mobility serving cell change. The conditional reconfiguration includes at least one of an execution condition, an indication of a candidate target cell for L1/L2 mobility, and a lower layer command. The serving network node may also receive an indication from the target network node (e.g., via the and/or from the CU connected to the serving and target nodes) where the UE executes the L1/L2 based inter-cell mobility serving cell change, in response to which the serving network node starts late data forwarding and releases or suspends the UE's connection, e.g., after the UE accesses the target network node. The serving network node may further receive an indication from the UE that this UE has executed the L1/L2 based inter-cell mobility serving cell change, in response to which the serving network node may release or suspend the UE's connection (the UE may send this indication before or after connecting to the target network node).

Aspects of the disclosure further present methods for a target network node, such as a target gNB, a target DU, or a target CU, to configure and to control the execution of a L1/L2 based inter-cell mobility serving cell change for a UE, based on the fulfillment of an execution condition (e.g., based on measurements) using a conditional reconfiguration. The target network node may also transmit an indication to the serving network node (e.g., via a CU connected to the serving and target nodes), indicating that the UE executed the L1/L2 based inter-cell mobility serving cell change.

One aspect relates to a method, performed by a UE operative in a wireless communication network, of performing an L1/L2 based inter-cell mobility serving cell change. A message containing at least one conditional reconfiguration for L1/L2 based inter-cell mobility serving cell change is received from a serving network node controlling a serving cell. Each conditional reconfiguration includes at least one of an execution condition, an indication of a candidate target cell for L1/L2 mobility, and a lower layer command. Network conditions are monitored. Upon detecting that a received execution condition is fulfilled, a conditional reconfiguration, resulting in a L1/L2 based inter-cell mobility serving cell change to a candidate target cell, is executed.

Another aspect relates to a wireless device operative in a wireless communication network. The wireless device includes communication circuitry configured to communicate with other network nodes, and processing circuitry operatively connected to the communication circuitry. The processing circuitry is configured to receive, from a serving network node controlling a serving cell, a message containing at least one conditional reconfiguration for L1/L2 based inter-cell mobility serving cell change, each conditional reconfiguration including at least one of an execution condition, an indication of a candidate target cell for L1/L2 mobility, and a lower layer command; monitor network conditions; and upon detecting that a received execution condition is fulfilled, execute a conditional reconfiguration resulting in a L1/L2 based inter-cell mobility serving cell change to a candidate target cell.

Yet another aspect relates to a method, performed by a serving network node operative in a wireless communication network, of controlling the execution of an L1/L2 based inter-cell mobility serving cell change of a UE from a source cell to a candidate target cell operative in the wireless communication network, based on the fulfillment of an execution condition. A message containing at least one conditional reconfiguration for L1/L2 based inter-cell mobility serving cell change is transmitted to the UE. Each conditional reconfiguration includes at least one of an execution condition, an indication of a candidate target cell for L1/L2 mobility, and a lower layer command. In response to the UE monitoring network conditions, and upon detecting that a received execution condition is fulfilled, executing a conditional reconfiguration resulting in a L1/L2 based inter-cell mobility serving cell change to a candidate target cell, an indication of a successful conditional L1/L2 inter-cell mobility serving cell change for the UE is received from a network node.

Still another aspect relates to a network node, configured as a serving network node operative in a wireless communication network. The network node includes communication circuitry configured to communicate with other network nodes, and processing circuitry operatively connected to the communication circuitry. The processing circuitry is configured to transmit, to the wireless device, a message containing at least one conditional reconfiguration for L1/L2 based inter-cell mobility serving cell change, each conditional reconfiguration including at least one of an execution condition, an indication of a candidate target cell for L1/L2 mobility, and a lower layer command; and in response to the wireless device monitoring network conditions, and upon detecting that a received execution condition is fulfilled, executing a conditional reconfiguration resulting in a L1/L2 based inter-cell mobility serving cell change to a candidate target cell, receive, from a network node, an indication of a successful conditional L1/L2 inter-cell mobility serving cell change for the wireless device.

Still another aspect relates to a method, performed by a candidate target network node operative in a wireless communication network, of controlling the execution of a L1/L2 based inter-cell mobility serving cell change of wireless device from a source cell to a candidate target cell operative in the wireless communication network, based on the fulfillment of an execution condition. A request to configure a context for the wireless device for L1/L2 inter-cell mobility is received from a network node. The request includes a conditional indication. In response to the wireless device monitoring network conditions, and upon detecting that a received execution condition is fulfilled, executing a conditional reconfiguration resulting in a L1/L2 based inter-cell mobility serving cell change to a candidate target cell, receiving, from the wireless device, an uplink message.

Still another aspect relates to a network node, configured as a serving network node operative in a wireless communication network. The network node includes communication circuitry configured to communicate with other network nodes, and processing circuitry operatively connected to the communication circuitry. The processing circuitry is configured to receive, from a network node, a request to configure a context for the wireless device for L1/L2 inter-cell mobility, the request including a conditional indication; and in response to the wireless device monitoring network conditions, and upon detecting that a received execution condition is fulfilled, executing a conditional reconfiguration resulting in a L1/L2 based inter-cell mobility serving cell change to a candidate target cell, receive, from the wireless device, an uplink message.

### BRIEF DESCRIPTION OF THE DRAWINGS

The present disclosure will now be described more fully hereinafter with reference to the accompanying drawings, in which aspects of the disclosure are shown. However, this disclosure should not be construed as limited to the aspects set forth herein. Rather, these aspects are provided so that this disclosure will be thorough and complete, and will fully convey the scope of the disclosure to those skilled in the art. Like numbers refer to like elements throughout.

FIG. 1 is a signaling diagram of RRC-based Conditional Handover operation.

FIG. 2 is a block diagram of a UE in Handover.

FIG. 3 is a flow diagram of a method, by a wireless device, of performing an L1/L2 based inter-cell mobility serving cell change.

FIG. 4 is a flow diagram of a method, by a conditional handover source network node, of controlling the execution of an L1/L2 based inter-cell mobility serving cell change of a UE from a source cell to a candidate target cell, based on the fulfillment of an execution condition.

FIG. 5 is a flow diagram of a method, by a conditional handover target network node, of controlling the execution of an L1/L2 based inter-cell mobility serving cell change of a UE from a source cell to a candidate target cell, based on the fulfillment of an execution condition.

FIG. 6 is a hardware block diagram of a wireless device.

FIG. 7 is a functional block diagram of a wireless device.

FIG. 8 is a hardware block diagram of a network node.

FIG. 9 is a functional block diagram of a conditional handover source network node.

FIG. 10 is a functional block diagram of a conditional handover target network node.

FIG. 11 is a signaling diagram of L1/L2 inter-cell mobility according to one aspect.

FIG. 12 is a signaling diagram of L1/L2 inter-cell mobility according to another aspect.

FIG. 13 is a signaling diagram of L1/L2 inter-cell mobility according to yet another aspect.

FIG. 14 is a block diagram of a communication system.

FIG. 15 is a block diagram of a UE.

FIG. 16 is a block diagram of a network node.

FIG. 17 is a block diagram of a host device.

FIG. 18 is a block diagram of a virtualization environment.

FIG. 19 is a block diagram of a host communicating via a network node with a UE over a partially wireless network connection.

### DETAILED DESCRIPTION

For simplicity and illustrative purposes, the present disclosure is described by referring mainly to an exemplary aspect thereof. In the following description, numerous specific details are set forth in order to provide a thorough understanding of the present disclosure. However, it will be readily apparent to one of ordinary skill in the art that the present disclosure may be practiced without limitation to these specific details. In this description, well known methods and structures have not been described in detail so as not to unnecessarily obscure the present disclosure

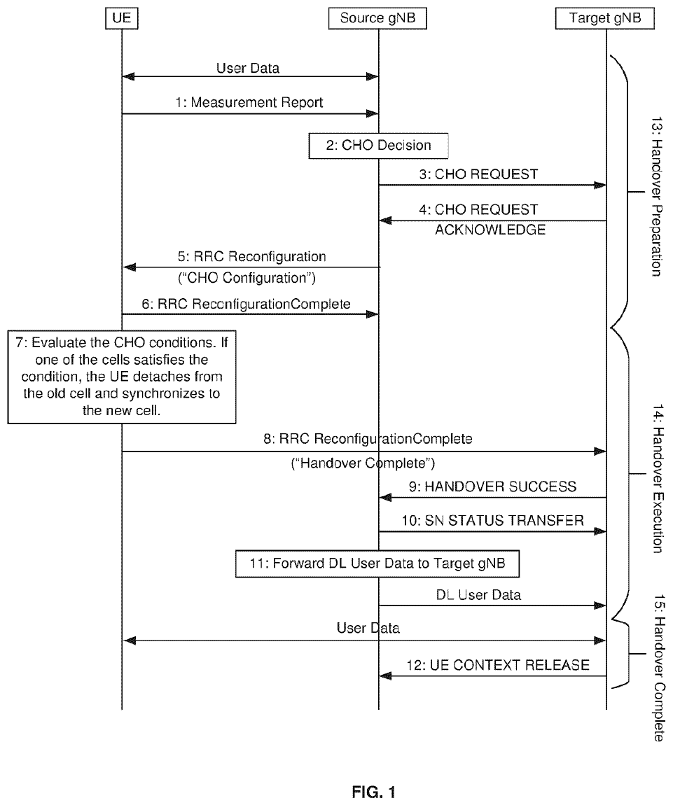

FIG. 1 is a signaling diagram depicting the 3GPP-defined, RRC-based, CHO process. The process may be conceptually divided into three phases, as indicated to the right of the diagram: Handover Preparation (13), Handover Execution (14), and Handover Completion (15).

In Handover Preparation (13), at steps 1-2, the UE and source gNB have an established connection and are exchanging user data. Due to some trigger, e.g., a measurement report from the UE, the source gNB decides to configure one or multiple CHO candidate cells. The threshold used for the measurement reporting should ideally be chosen lower than the one in the handover execution condition. This allows the serving cell to prepare the handover when the radio link to the UE is still stable. The execution of the handover is done at a later point in time (and threshold), which is considered optimal for the handover execution.

At step 3, the source gNB sends a CHO REQUEST to the target gNB with necessary information to prepare a conditional handover at the target node. The information includes, among other things, the current source configuration and the UE capabilities.

At step 4, the target gNB prepares the handover and responds with a CHO REQUEST ACKNOWLEDGE to the source gNB, which includes the handover command (which is an RRCReconfiguration message) to be sent to the UE and later executed, if/when the execution condition is fulfilled. The handover command includes information needed by the UE to access the target cell, e.g., random access configuration, a new C-RNTI assigned by the target access node, and security parameters enabling the UE to calculate the target security key so the UE can send the handover complete message (an RRCReconfigurationComplete message).

At steps 5-6, to configure a candidate target cell, the source node sends the CHO configuration (i.e., an RRCReconfiguration message) to the UE, which contains the handover command and the associated execution condition. The handover command (also an RRCReconfiguration message) is the same as the one generated by the target node during the handover preparation phase (in steps 3-4), and the execution condition is generated by the source node.

Later, during Handover Execution (14), at steps 7-8, if the execution condition is met, the UE executes the handover by performing random access and sending the handover complete message (i.e., an RRCReconfigurationComplete message) to the target node.

In response, at step 9, the target gNB sends a HANDOVER SUCCESS message to the source gNB indicating the UE has successfully established the target connection.

Upon reception of the handover success indication, at steps 10-11, the source gNB stops scheduling any further DL or UL data to the UE, and sends a SN STATUS TRANSFER message to the target gNB indicating the latest PDCP SN transmitter and receiver status. The source node now also starts to forward User Data to the target node.

In Handover Completion (15), upon receiving the handover complete message, at step 12, the target node can start exchanging user data with the UE. The target node also requests the network Access and Mobility Management Function (AMF) to switch the DL data path from the User Plane Function (UPF) from the source node to the target node (not shown). Once the path switch is completed, the target node sends the UE CONTEXT RELEASE to the source node.

The conditional handover concept in 3GPP Rel-16 has been generalized into a generic conditional reconfiguration framework, wherein a UE may be configured in advance with also other types of reconfigurations which can be executed by an RRCReconfiguration message (in NR) or an RRCConnectionReconfiguration message (in LTE) upon the triggering of a certain associated condition.

The Conditional PSCell Addition (CPA) and Conditional PSCell Change (CPC) are examples of two other types of reconfigurations, which use the conditional reconfiguration framework, but operating on the PSCell in the Multi-Radio Dual Connectivity (MR-DC) scenario. In CPA and CPC, when an execution condition is met, rather than a handover, a PSCell Addition (in case of CPA) or a PSCell change (in case of CPC) is executed. CPC and CPA were introduced in 3GPP Rel-16 and Rel-17, respectively.

As part of 3GPP Release 18, a new work item known as Further NR mobility enhancements is being considered. This work item aims to, among other things, specify L1/L2-based inter-cell mobility. According to RP-221799, 3GPP Work Item Description (WID): Further NR mobility enhancements, MediaTek, 3GPP TSG RAN Meeting #96, Budapest, Hungary, Jun. 6-9, 2022, the following is included as one objective of the work:
1. To specify mechanism and procedures of L1/L2 based inter-cell mobility for mobility latency reduction:
   Configuration and maintenance for multiple candidate cells to allow fast application of configurations for candidate cells [RAN2, RAN3]
   Dynamic switch mechanism among candidate serving cells (including SpCell and SCell) for the potential applicable scenarios based on L1/L2 signalling [RAN2, RAN1]
   L1 enhancements for inter-cell beam management, including L1 measurement and reporting, and beam indication [RAN1, RAN2]
      Note 1: Early RAN2 involvement is necessary, including the possibility of further clarifying the interaction between this bullet with the previous bullet.
   Timing Advance management [RAN1, RAN2]
   CU-DU interface signaling to support L1/L2 mobility, if needed [RAN3]
Note 2: FR2 specific enhancements are not precluded, if any.
Note 3: The procedure of L1/L2 based inter-cell mobility are applicable to the following scenarios:
   Standalone. CA and NR-DC case with serving cell change within one CG
   Intra-DU case and intra-CU inter-DU case (applicable for Standalone and CA: no new RAN interfaces are expected)
   Both intra-frequency and inter-frequency
   Both FR1 and FR2
   Source and target cells may be synchronized or non-synchronized

According to this WID, the following is part of the justification:

When the UE moves from the coverage area of one cell to another cell, at some point a serving cell change needs to be performed. Currently serving cell change is triggered by L3 measurements and is done by RRC signalling triggered Reconfiguration with Synchronisation for change of PCell and PSCell, as well as release add for SCells when applicable. All cases involve complete L2 (and L1) resets, leading to longer latency, larger overhead, and longer interruption time than beam switch mobility. The goal of L1/L2 mobility enhancements is to enable a serving cell change via L1/L2 signalling, in order to reduce the latency, overhead and interruption time.

The WID for Rel-18 Further NR Mobility Enhancements, in 3GPP referred to as L1/L2 based inter-cell mobility, the overall procedure and signaling to configure and execute L1/L2 based inter-cell mobility serving cell change is still open. A goal of L1/L2 based inter-cell mobility is to reduce latency, overhead, and interruption time.

This disclosure uses the term “L1/L2 based inter-cell mobility,” as this is the term used in the Work Item Description in 3GPP. However, the terms L1/L2 mobility, L1-mobility, L1 based mobility, L1/L2-centric inter-cell mobility, and L1/L2 inter-cell mobility may also be used interchangeably.

Although specific techniques for L1/L2 based inter-cell mobility have not yet been standardized, the basic principle is that a lower layer protocol entity triggers a change of the UE's serving cell (e.g., change of PCell, from a source to a target PCell), possibly with a change of beam to be monitored for a control channel, e.g., a change of Transmission Configuration Indication (TCI) state.

As used herein, a “lower layer” protocol, command, or the like, refers to a lower layer in the air interface protocol stack, as compared to the RRC protocol. For example, the Medium Access Control (MAC) is considered a lower layer protocol, as it is “below” RRC in the air interface protocol stack. Another example of lower layer protocol is the Layer 1 (or Physical Layer, L1).

Another relevant aspect is that in a multi-beam scenario, a cell can be associated to multiple Synchronization Signal Blocks (SSB), and during a half-frame, different SSBs may be transmitted in different spatial directions (i.e., using different beams, spanning the coverage area of a cell). Similar reasoning may be applicable to Channel State Information-Reference Signal (CSI-RS) resources, which may also be transmitted in different spatial directions. The phrase “L1/L2 based inter-cell mobility serving cell change” refers to the process of a UE changing its serving cell from a source cell to a target cell, using L1/L2 based inter-cell mobility.

As used herein, a “conditional reconfiguration” uses an execution condition, or a combination of multiple executing conditions, that is/are evaluated, and when fulfilled, results in the UE performing an action, such as executing the conditional reconfiguration (sometimes known as executing the condition), for example applying a message, parts of a message or at least one information element, or performing a serving cell switch or change. Known existing examples of conditional reconfiguration are conditional handover (CHO), Conditional PSCell Change (CPC) and Conditional PSCell Addition (CPA). According to aspects of the present disclosure, upon fulfillment of the execution conditions(s) the UE performs a L1/L2 based inter-cell mobility serving cell change, which may also be referred to as a cell change and/or cell switching, rather than a reconfiguration.

As used herein, a candidate target cell, or L1/L2 inter-cell mobility candidate cell, or target candidate cell for L1/L2 inter-cell mobility, refer to a cell with which the UE is configured when configured with L1/L2 inter-cell mobility, which is a cell the UE moves to in a L1/L2 inter-cell mobility procedure upon fulfillment of the associated execution condition. These cells may also be called candidate cells, candidates, mobility candidates, non-serving cells, additional cells, deactivated cells, etc.

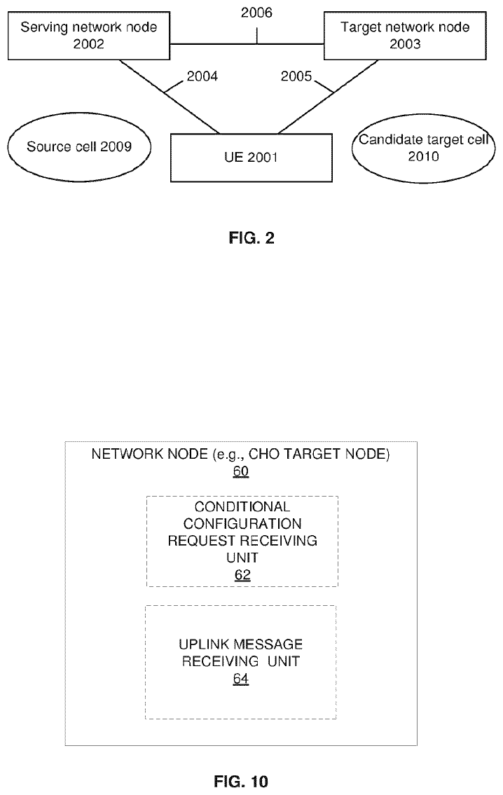

FIG. 2 is a block diagram depicting some network entities involved in aspects of the present disclosure. The User Equipment (UE) 1001 is a wireless device, such as a cellular smartphone, sometimes connected to the serving network node 2002 over a wireless interface 2004 and sometimes connected to a target network node 2003, to which the UE 2001 is connected over a wireless interface 2005.

In the context of a mobility procedure, such as a L1/L2 based inter-cell mobility serving cell change, for the UE, the serving network node 2002 controls a source cell 2007 and the target network node 2003 controls a candidate target cell 2008. The serving network node 2002 may be a base station such as, e.g., gNB, or, e.g., in case of a distributed CU/DU RAN architecture, a distributed unit, sometimes known as either gNB-DU or DU, or alternatively a central unit, CU, sometimes referred to as the serving CU, known as either a gNB-CU, CU, gNB-CU-CP or gNB-CU-UP.

The target network node 2003 may be a base station such as, e.g., a gNB, or, e.g., in case of a distributed CU/DU RAN architecture, a distributed unit, sometimes known as either gNB-DU or DU.

The serving network node 2002 and the target network node 2003 are connected over an interface 2006.

### UE Method

One aspect relates to a UE to execute a L1/L2 based inter-cell mobility serving cell change from a source cell to a candidate target cell based on the fulfillment of an execution condition.

Another aspect relates to the UE method wherein the UE receives, from a serving network node, a message (e.g., RRC Reconfiguration, RRC Resume) containing at least one conditional reconfiguration for L1/L2 based inter-cell mobility serving cell change. Another aspect relates to the UE method wherein the conditional reconfiguration includes at least one of:
an execution condition, such as one of
   A condition related to an RRM measurement, such as an A3 or A5 type of event
   A condition related to an L1 measurement, such as a CSI measurement
   A condition related to at least one beam measurement, wherein a beam may correspond to a spatial direction in which a signal and/or channel is transmitted. A Beam measurement may correspond to a measurement on a reference signal type (CSI-RS and/or SSB), e.g., SS-RSRP, CSI-RSRQ, wherein the reference signal is transmitted in a spatial direction, i.e., in a beam.
   A condition related to at least one measurement on one or more reference signals (RSs), wherein each RS is associated to a RS identifier. For example, the UE may perform measurements on SSBs, e.g., SSB index 1, SSB index 2, etc.
   A condition related to measurements on beams from a serving cell (e.g., PCell) and one or more candidate cells for L1/L2 inter-cell mobility (e.g., in the same serving frequency as the PCell). For example, the condition may be considered to be fulfilled if at least a beam of the target candidate cell is better than a serving beam in the PCell, wherein a serving beam correspond to a beam associated to an active TCI state.
   A condition related to measurements on SSBs from a serving cell (e.g., PCell) and one or more candidate target cells for L1/L2 inter-cell mobility (e.g., in the same serving frequency as the PCell). For example, the condition may be considered to be fulfilled if at least one SSB (e.g., with SSB index X) of the candidate target cell is better (or an offset better) than the SSB of the PCell configured as QCL source of an active TCI state e.g. SS-RSRP of SSB index X of the candidate target cell is an offset better than the SSB of the PCell configured as QCL source of an active TCI state. A better SSB may be defined in terms of a measurement quantity such as RSRP, RSRQ, SINR, RSSI, etc.
   The condition may be considered to be fulfilled if at least one SSB (e.g., with SSB index X) of the candidate target cell has an SS-RSRP (or other measurement quantity) greater (or an offset greater) than the SS-RSRP (or other measurement quantity) of the SSB of the PCell configured as QCL source of an active TCI state e.g. SS-RSRP of SSB index X of the target candidate is an offset better than the SSB of the PCell configured as QCL source of an active TCI state.
an indication of a candidate target cell for L1/L2 mobility (associated to the execution condition), such as one of more of:
   a Cell Group configuration (e.g., CellGroupConfig IE) including the target cell candidate configuration(s), wherein the configuration(s) comprises UE-specific parameters (e.g., parameters within ServingCellConfig) and/or cell-specific parameters (e.g., parameters within ServingCellConfigCommon).
   a Serving Cell configuration(s), wherein the configuration(s) comprises UE-specific parameters (e.g., parameters within ServingCellConfig) and/or cell-specific parameters (e.g., parameters within ServingCellConfigCommon).
   An index or identifier that the UE need to switch to by keeping the current configuration. In this case, the identifier can be e.g., the PCI, Serving cell ID
a lower layer command for L1/L2 based inter-cell mobility serving cell change, such as the L1/L2 signaling which when applied by the UE triggers the UE to perform L1/L2 based inter-cell mobility serving cell change execution. The UE is configured with the execution condition, the configuration of a candidate target cell and the command for L1/L2 based inter-cell mobility serving cell change, which are stored when the UE is configured. Then, the UE monitors the execution condition(s) and when the execution condition is fulfilled for the candidate target cell, the UE applies the lower layer command and executes the L1/L2 inter-cell mobility serving cell change to the candidate target cell. Upon applying the command, the UE starts to operate according to the configuration of the candidate target cell.
   In one aspect, there are two steps: in a first step the UE is configured with the candidate target cell (or multiple candidates), i.e., the UE gets prepared to receive a lower layer signaling indicating the configured target candidate cell, the lower layer signaling indicating the UE to perform a L1/L2 based inter-cell mobility serving cell change to the target candidate cell, e.g., by the lower layer command including an indication of the candidate target cell. In a second step, the UE receives the conditional reconfiguration, including the execution condition, and the lower layer command to be stored (which may be provided to the UE in different manners, as disclosed below). The lower layer command may be provided to the UE in different manners:
   In one aspect the lower layer command is provided to the UE as an RRC container, so that upon reception, the UE recognizes that it is a lower layer command (such as a MAC CE indicating L1/L2 inter-cell mobility serving cell change) for the candidate target cell and stores the command. When the condition is fulfilled for the candidate target cell, the protocol layer for the lower layer command is notified and receives the command (so that for the lower layers the process being condition is transparent and handled by the RRC layer where the command is stored).
   In another aspect the lower layer command is provided to the UE by its own lower layer entity, e.g., if the lower layer command is a MAC CE, that is received by the MAC entity at the UE and stored, wherein the MAC CE includes an indication that the command is to be stored and only applied upon fulfillment of an associated execution condition.
      In one option the lower layer command includes an indication of the associated execution condition;
      In one option the UE determines the execution condition associated to the lower layer command by determining that an execution condition is associated to a candidate target cell A and determining that the lower layer command is associated to the same candidate target cell A;
   In another aspect, there is also a third step. After the UE is configured with the candidate target cell (or multiple candidates) in the first step, and after the UE has received a command that indicates the conditional reconfiguration (including the conditional reconfiguration and the lower layer command to be stored) in the second step, in a third step the UE may receive a further command for indicating which of this conditional reconfigurations stored at the UE are activated or deactivated. In one example, for a conditional reconfiguration that is activated, this can also be considered as an indication for the UE to keep the time alignment with the candidate target cell linked to this conditional reconfigurations or to perform measurements even if the candidate target cell linked to this conditional reconfigurations is not the serving cell of the UE.
      In one aspect the command is provided to the UE as an RRC container, so that upon reception, the UE recognizes which conditional reconfigurations should be considered activated and which deactivated.
      In another aspect the command is provided to the UE by a lower layer entity e.g., if the lower layer command is a MAC CE, that is received by the MAC entity at the UE and stored, wherein the MAC CE includes an indication on which conditional reconfigurations should be considered activated and which deactivated.

In some aspects, the UE stores the candidate target cell configuration upon reception of the conditional reconfiguration and monitors the execution condition (e.g., by performing one or more measurements on the candidate target cell and determining whether the execution condition is fulfilled or not, for example, if the candidate target cell is an offset better than the current serving cell). Upon fulfillment of the execution condition associated to the candidate target cell the UE executes the L1/L2 based inter-cell mobility serving cell change to the candidate target cell which comprises one or more of:
the UE applying the candidate target cell configuration and activating a TCI state configuration associated to the candidate target cell;
the UE indicating to the lower layer the lower layer command which has been stored;
the UE switching its current configuration to the candidate target cell configuration starting to operate accordingly;
the UE receiving control channels and data channels in a Downlink beam of the candidate target cell, according to the target candidate cell configuration;
the UE transmitting a lower layer Uplink message (e.g., a message defined in the MAC layer, such as a MAC CE for acknowledging the L1/L2 based inter-cell mobility serving cell change);
the UE stopping to monitor control and/or data channels in the serving cell. Here the serving cell may still be stored by the UE and it may become one of the candidate target cell configurations.

Another aspect relates to the UE method wherein the UE evaluates an execution condition.

Another aspect relates to the UE method wherein the UE, when an execution condition is fulfilled, executes a conditional reconfiguration that results in a L1/L2 based inter-cell mobility serving cell change to a candidate target cell.

Another aspect relates to the UE method wherein the L1/L2 based inter-cell mobility serving cell change to a candidate target cell includes at least one of
Change of Transmission Configuration Indication, TCI, state
Change of Cell Group . . .
Change of Serving Cell (e.g., PCell, PScell)
Change of PCI
DL and/or UL synchronization towards the candidate target cell
Sending an indication to the candidate target cell to acknowledge that the L1/L2 based inter-cell mobility serving cell change has happened. In this case, the acknowledgement may be sent to the candidate target cell according to the following signaling alternative:
   If the UE has kept the time alignment with the candidate target cell at the time that the L1/L2 based inter-cell mobility serving cell change happened, then the acknowledgment may be a scheduling request (SR) sent to the candidate target cell or simply the first UL transmission sent to the candidate target cell whichever this is.
   If the UE has not kept any time alignment with the candidate target cell at the timer that the L1/L2 based inter-cell mobility serving cell change happened, then the acknowledgement may be indicated within a random access preamble, a scheduling request (after random access is completed), or the first UL RRC message sent (after random access is completed).
Sending an indication to the serving cell to acknowledge that the L1/L2 based inter-cell mobility serving cell change has happened. In this case, the acknowledgement may be sent to the serving cell according to the following signaling alternative:
   In one option the acknowledgement is provided to the serving cell as an RRC container, so that upon reception, the serving cell recognizes that the UE has performed a L1/L2 based inter-cell mobility serving cell change and eventually which conditional reconfigurations has been used.
   In another option the acknowledgement is provided to the UE by a lower layer entity e.g. if the lower layer command is a MAC CE, that is received by the MAC entity at the UE and stored, wherein the MAC CE includes an indication that the UE has performed a L1/L2 based inter-cell mobility serving cell change and eventually which conditional reconfigurations has been used.

Another aspect relates to the UE method wherein the execution condition is fulfilled comprises at least one of.
A condition related to an RRM measurement, such as an A3 or A5 type of event, is fulfilled, such as the signal strength or quality of a cell becomes X dB better than another cell.
A condition related to an L1 measurement, such as a CSI measurement, is fulfilled, such as the SS reference signal received power (SS-RSRP) of a cell becomes X dB better than another cell
   In a set of embodiments, the execution condition is associated to a candidate target cell.
   In a set of embodiments, the execution condition is associated to a serving cell
   In a set of embodiments, the execution condition is associated to a beam and/or reference signal (e.g., SSB index and/or CSI-RS index) of the candidate target cell or serving cell.

In some aspects, upon fulfillment of the condition of the candidate target cell, the UE selects the candidate target cell and selects a beam and/or Reference Signal identifier (e.g. SSB index, CSI-RS resource identity) and/or a TCI state to be activated in the candidate target cell, for example, to transmit an UL message to the target candidate cell (e.g. a random access preamble) and/or to receive information from the candidate target cell.

In some aspects, upon fulfillment of the condition of the candidate target cell, the UE transmits, to the serving network node, a signal or message in the serving cell. In one example, the signal or message includes an indication of the selected candidate target cell.

FIG. 3 depicts a method 100, performed by a UE operative in a wireless communication network, of performing an L1/L2 based inter-cell mobility serving cell change. A message containing at least one conditional reconfiguration for L1/L2 based inter-cell mobility serving cell change is received from a serving network node controlling a serving cell (block 102). Each conditional reconfiguration includes at least one of an execution condition, an indication of a candidate target cell for L1/L2 mobility, and a lower layer command. Network conditions are monitored (block 104). Upon detecting that a received execution condition is fulfilled (block 106), a conditional reconfiguration, resulting in a L1/L2 based inter-cell mobility serving cell change to a candidate target cell, is executed (block 108).

### Source, or Serving, Node Method

One aspect relates to a method for a serving network node, such as a source gNB, a source DU, or a source CU, to control the execution of a L1/L2 based inter-cell mobility serving cell change of a UE from a source cell to a candidate target cell based on the fulfillment of an execution condition.

Another aspect relates to the serving node method wherein the serving network node receives, from a target network node, a conditional reconfiguration for L1/L2 based inter-cell mobility serving cell change.

Another aspect relates to the serving node method wherein the serving network node transmits, to the UE, a message containing at least one conditional reconfiguration for L1/L2 based inter-cell mobility serving cell change

Another aspect relates to the serving node method wherein the conditional reconfiguration includes at least one of
an execution condition
an indication of a candidate target cell.
A method wherein the execution condition is fulfilled comprises at least one of
A condition related to an RRM measurement, such as an A3 or A5 type of event, is fulfilled
A condition related to an L1 measurement, such as a CSI measurement, is fulfilled

In one aspect, the serving network node provides to the UE a lower layer command for L1/L2 inter-cell mobility serving cell change, to be stored upon reception. The lower layer command is to be applied only upon the fulfillment of the associated execution condition.

Another aspect relates to the serving node method wherein the serving network node receiving an indication from the UE that indicate that this UE has executed the L1/L2 based inter-cell mobility serving cell change in response to which the serving network node releases/suspend the UE's connection (the UE may send this indication after or before connecting to the target network node).

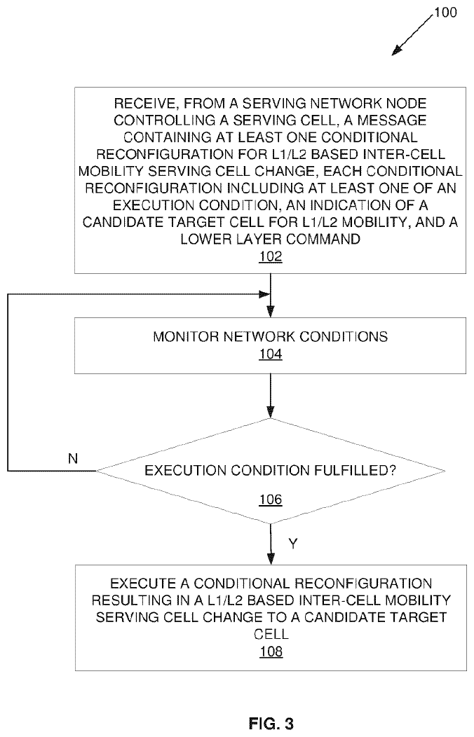

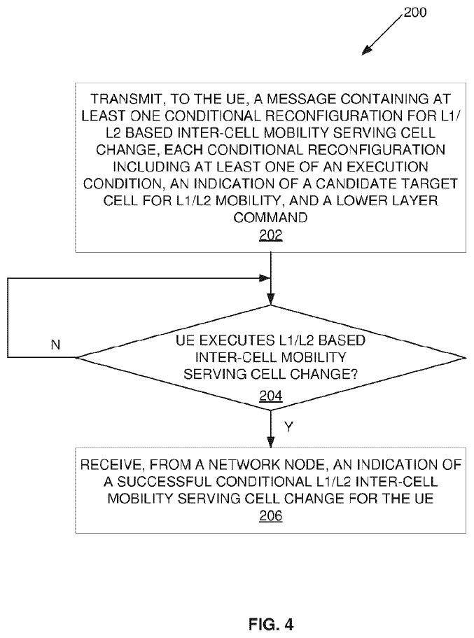

FIG. 4 depicts a method 200, performed by a serving network node operative in a wireless communication network, of controlling the execution of an L1/L2 based inter-cell mobility serving cell change of a UE from a source cell to a candidate target cell operative in the wireless communication network, based on the fulfillment of an execution condition. A message containing at least one conditional reconfiguration for L1/L2 based inter-cell mobility serving cell change is transmitted to the UE (block 202). Each conditional reconfiguration includes at least one of an execution condition, an indication of a candidate target cell for L1/L2 mobility, and a lower layer command. In response to the UE monitoring network conditions, and upon detecting that a received execution condition is fulfilled, executing a conditional reconfiguration resulting in a L1/L2 based inter-cell mobility serving cell change to a candidate target cell (block 204), an indication of a successful conditional L1/L2 inter-cell mobility serving cell change for the UE is received from a network node (block 206).

### Candidate Target Node Method

One aspect relates to a method for a target network node, such as a target gNB, a target DU, or a target CU, to control the execution of a L1/L2 based inter-cell mobility serving cell change of a UE from a source cell to a candidate target cell based on the fulfillment of an execution condition.

Another aspect relates to the target node method wherein the target network node transmits, to a serving network node, a conditional reconfiguration for L1/L2 based inter-cell mobility serving cell change.

Another aspect relates to the target node method wherein the conditional reconfiguration includes at least one of
an execution condition
an indication of a candidate target cell.

Another aspect relates to the target node method wherein the target network node determines an execution condition.

Another aspect relates to the target node method wherein the target network node prepares a conditional reconfiguration.

In some aspects, the target network node provides to the serving network node (e.g., CU and/or the Serving DU) a lower layer command for L1/L2 inter-cell mobility serving cell change, to be stored by the UE upon its reception. The lower layer command is to be applied only upon the fulfillment of the associated execution condition. That may be provided with the target candidate cell configuration.

In some aspects, the configuration of the candidate target cell is generated by a target candidate node, which is responsible for the candidate target cell, wherein that is generated upon reception by the target candidate node (target candidate DU) of a request from a serving network node (e.g., CU and/or the Serving DU) for configuring a UE with L1/L2 based inter-cell mobility serving cell change. In one option, the request includes an indication that the procedure is conditional, i.e., the UE executes the L1/L2 based inter-cell mobility serving cell change to the target candidate cell upon fulfillment of an execution condition to be monitored by the UE. In response, the target candidate node transmits to the serving node (e.g., CU and/or the Serving DU) the configuration of a candidate target cell.

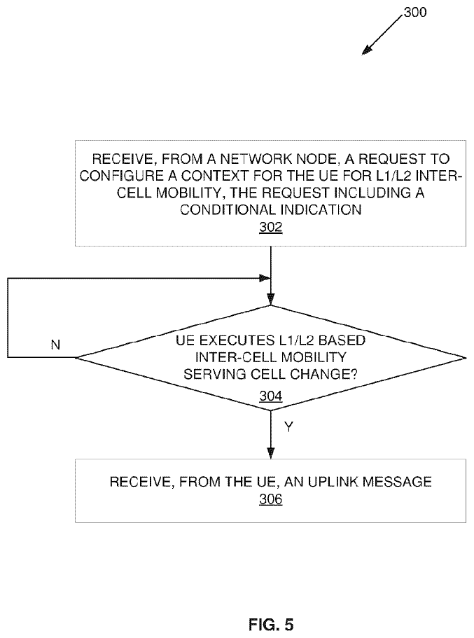

FIG. 5 depicts the steps in a method 300, performed by a candidate target network node operative in a wireless communication network, of controlling the execution of a Layer 1 or Layer 2 (L1/L2) based inter-cell mobility serving cell change of User Equipment (UE) from a source cell to a candidate target cell operative in the wireless communication network, based on the fulfillment of an execution condition. A request to configure a context for the UE for L1/L2 inter-cell mobility is received from a network node (block 302). The request includes a conditional indication. In response to the UE monitoring network conditions, and upon detecting that a received execution condition is fulfilled, executing a conditional reconfiguration resulting in a L1/L2 based inter-cell mobility serving cell change to a candidate target cell (block 304), receiving, from the UE, an uplink message (block 306).

### Apparatuses and Computer Program Products

Apparatuses described herein may perform the methods 100, 200, 300 herein and any other processing by implementing any functional means, modules, units, or circuitry. In one aspects of the disclosure, for example, the apparatuses comprise respective circuits or circuitry configured to perform the steps shown in the method figures. The circuits or circuitry in this regard may comprise circuits dedicated to performing certain functional processing and/or one or more microprocessors in conjunction with memory. For instance, the circuitry may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory may include program instructions for executing one or more telecommunications and/or data communications protocols as well as instructions for carrying out one or more of the techniques described herein, in several aspects of the disclosure. In aspects of the disclosure that employ memory, the memory stores program code that, when executed by the one or more processors, carries out the techniques described herein.

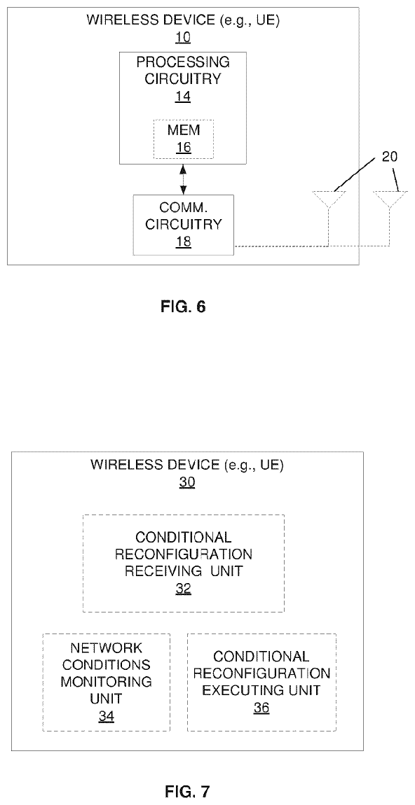

FIG. 6 for example illustrates a hardware block diagram of a wireless device 10 as implemented in accordance with one or more aspects of the disclosure. As shown, the wireless device 10 includes processing circuitry 14 and communication circuitry 18. The communication circuitry 18 (e.g., radio circuitry) is configured to transmit and/or receive information to and/or from one or more other nodes, e.g., via any communication technology. Such communication may occur via one or more antennas 20 that are either internal or external to the wireless device 10, as indicated by dashed lines. The processing circuitry 14 is configured to perform processing described above, such as by executing instructions stored in memory 16. The processing circuitry 14 in this regard may implement certain functional means, units, or modules.

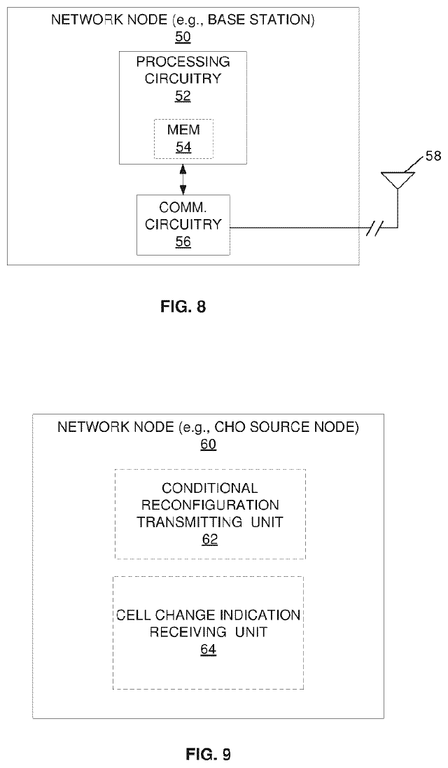

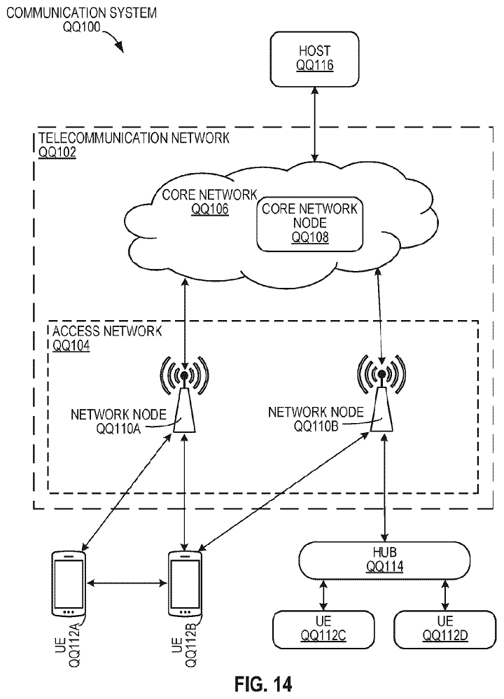

FIG. 7 illustrates a functional block diagram of a wireless device 30 in a wireless network according to still other aspects of the disclosure (for example, the wireless network shown in FIG. 14). As shown, the wireless device 30 implements various functional means, units, or modules, e.g., via the processing circuitry 14 in FIG. 8 and/or via software code. These functional means, units, or modules, e.g., for implementing method 100 herein, include for instance: conditional reconfiguration receiving unit 32; network conditions monitoring unit 34; and conditional reconfiguration executing unit 36.

Conditional reconfiguration receiving unit 32 is configured to receive, from a serving network node controlling a serving cell, a message containing at least one conditional reconfiguration for L1/L2 based inter-cell mobility serving cell change, each conditional reconfiguration including at least one of an execution condition, an indication of a candidate target cell for L1/L2 mobility, and a lower layer command. Network conditions monitoring unit 34 is configured to monitor network conditions. Conditional reconfiguration executing unit 36 is configured to, upon detecting that a received execution condition is fulfilled, execute a conditional reconfiguration resulting in a L1/L2 based inter-cell mobility serving cell change to a candidate target cell.

FIG. 8 illustrates a hardware block diagram of a network node 50 as implemented in accordance with one or more aspects of the disclosure. As shown, the network node 50 includes processing circuitry 52 and communication circuitry 56. The communication circuitry 56 is configured to transmit and/or receive information to and/or from one or more other nodes, e.g., via any communication technology. The network node 50 may function as a base station (e.g., eNB, gNB, etc.), and may wirelessly communicate with a plurality of wireless devices 10 via one or more antennas 58. As indicated by the broken line, the antennas 58 may be located remotely from the network node 50, such as on a tower or building. The processing circuitry 14 is configured to perform processing described above, such as by executing instructions stored in memory 54. Although represented as being within the network node 50, those of skill in the art understand that some or all of the processing circuitry 14 may be implemented as virtualized servers in a data center, e.g., in the so-called cloud. The processing circuitry 14 in this regard may implement certain functional means, units, or modules.

FIG. 9 illustrates a functional block diagram of a network node 60 in a wireless network according to still other aspects of the disclosure (for example, the wireless network shown in FIG. 14), in which the network node 60 is configured and/or operates as a CHO source node. As shown, the network node 60 implements various functional means, units, or modules, e.g., via the processing circuitry 54 in FIG. 8 and/or via software code. These functional means, units, or modules, e.g., for implementing the method(s) herein, include for instance: conditional reconfiguration transmitting unit 62; and cell change indication receiving unit 64.

Conditional reconfiguration transmitting unit 62 is configured to transmit, to the UE, a message containing at least one conditional reconfiguration for L1/L2 based inter-cell mobility serving cell change, each conditional reconfiguration including at least one of an execution condition, an indication of a candidate target cell for L1/L2 mobility, and a lower layer command. Cell change indication receiving unit 64 is configured to, in response to the UE monitoring network conditions, and upon detecting that a received execution condition is fulfilled, executing a conditional reconfiguration resulting in a L1/L2 based inter-cell mobility serving cell change to a candidate target cell, receive, from a network node, an indication of a successful conditional L1/L2 inter-cell mobility serving cell change for the UE.

FIG. 10 illustrates a functional block diagram of a network node 60 in a wireless network according to still other aspects of the disclosure (for example, the wireless network shown in FIG. 14), in which the network node 60 is configured and/or operates as a CHO target node. As shown, the network node 60 implements various functional means, units, or modules, e.g., via the processing circuitry 54 in FIG. 8 and/or via software code. These functional means, units, or modules, e.g., for implementing the method(s) herein, include for instance: conditional configuration request receiving unit 62; and uplink message receiving unit 64.

Conditional configuration request receiving unit 62 is configured to receive, from a network node, a request to configure a context for the UE for L1/L2 inter-cell mobility, the request including a conditional indication. Uplink message receiving unit 64 is configured to, in response to the UE monitoring network conditions, and upon detecting that a received execution condition is fulfilled, executing a conditional reconfiguration resulting in a L1/L2 based inter-cell mobility serving cell change to a candidate target cell, receive, from the UE, an uplink message.

Those skilled in the art will also appreciate that aspects of the disclosure herein further include corresponding computer programs.

A computer program comprises instructions which, when executed on at least one processor of an apparatus, cause the apparatus to carry out any of the respective processing described above. A computer program in this regard may comprise one or more code modules corresponding to the means or units described above.

Aspects of the disclosure further include a carrier containing such a computer program. This carrier may comprise one of an electronic signal, optical signal, radio signal, or computer readable storage medium.

In this regard, aspects of the disclosure herein also include a computer program product stored on a non-transitory computer readable (storage or recording) medium and comprising instructions that, when executed by a processor of an apparatus, cause the apparatus to perform as described above.

Aspects of the disclosure further include a computer program product comprising program code portions for performing the steps of any of the aspects of the disclosure herein when the computer program product is executed by a computing device. This computer program product may be stored on a computer readable recording medium.

### Signal Flow Diagrams

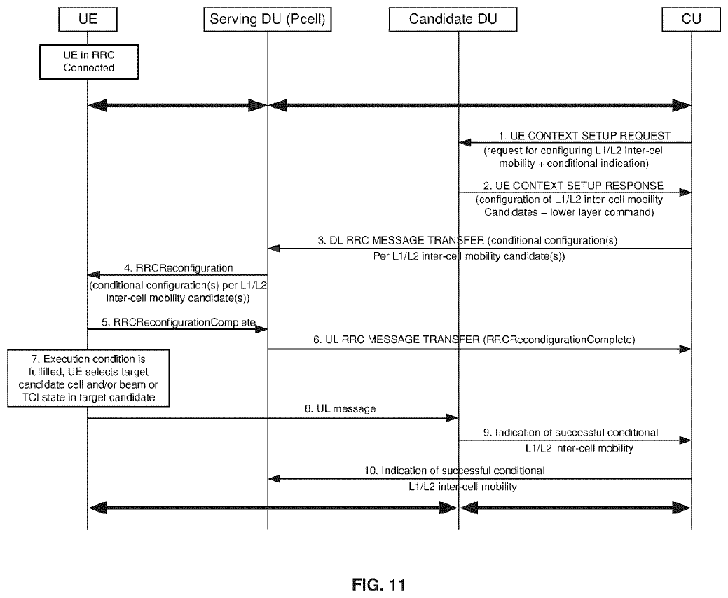

FIGS. 11-13 depict representative signal flow sequences for various aspects of the present disclosure. Those of skill in the art will readily recognize that these diagrams depict some possible ways to implement aspects disclosed herein; however, numerous variations are possible within the scope of the present disclosure, and these signal diagrams are illustrative but not limiting.

FIG. 11 illustrates one aspect of the disclosure in a distributed CU/DU RAN architecture. The UE is configured with a conditional reconfiguration for L1/L2 based inter-cell mobility, within which is a lower layer command generated by the candidate DU. The lower layer command is executed by the UE upon fulfilment of the condition.

Referring to FIG. 11, the main steps in this example are as follows. Initially, the UE is connected in the source cell with the serving DU.

Step 1. The CU initiates configuration of a conditional reconfiguration for candidate target cell(s) controlled by the candidate DU and transmits a message, such as a UE CONTEXT SETUP REQUEST message, to the candidate DU. The message includes a request to configure L1/L2 inter-cell mobility and a conditional indication.

Step 2. The candidate DU creates the conditional reconfiguration for L1/L2 based inter-cell mobility serving cell change for the L1/L2 inter-cell mobility candidate(s). The candidate DU also creates a lower layer command for L1/L2 based inter-cell mobility serving cell change for each candidate. That command may be provided with the conditional reconfiguration. The candidate DU returns the created information to the CU in a response message, such as a UE CONTEXT SETUP RESPONSE message.

Step 3. The CU transmits a message, such as a DL RRC MESSAGE TRANSFER message, to the serving DU, containing the conditional reconfiguration(s) including the lower layer command(s), for example within an RRCReconfiguration message.

Step 4. The serving DU transmits, to the UE, an RRCReconfiguration message containing the conditional configuration(s) per L1/L2 mobility candidate.

Step 5. The UE stores the received conditional reconfiguration(s) per L1/L2 mobility candidate and returns an RRCReconfigurationComplete message to the serving DU.

Step 6. The serving DU forwards the received RRCReconfigurationComplete message to the CU in an UL RRC MESSAGE TRANSFER message.

Step 7. The UE evaluates the execution condition(s) for the L1/L2 inter-cell mobility candidate(s). When an execution condition is fulfilled, the UE selects the target candidate and executes the conditional reconfiguration for this candidate. In this example, the UE applies the previously received lower layer command for L1/L2 based inter-cell mobility serving cell change for the selected target candidate, which results in the UE selecting target candidate cell and/or beam or TCI state in the target candidate cell.

Step 8. The UE transmits an UL message, sch as a lower layer (L1 or MAC) signal or message to the candidate DU in the selected target candidate cell.

Step 9. The candidate DU transmits an indication of successful conditional L1/L2 inter-cell mobility to the CU.

Step 10. The CU transmits an indication of successful conditional L1/L2 inter-cell mobility to the serving DU.

The UE is now connected in the target cell with the target DU.

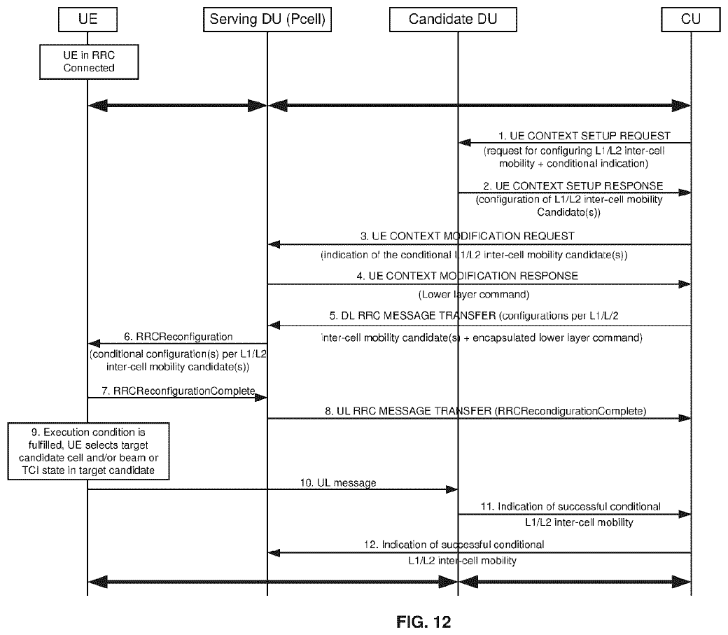

FIG. 12 illustrates another aspect of the disclosure in a distributed CU/DU RAN architecture. The UE is configured with a conditional reconfiguration for L1/L2 based inter-cell mobility, and the serving DU generates a lower layer command that is executed upon fulfilment of the condition and this command is provided to the UE via RRC.

Referring to FIG. 12, the main steps in this aspect are as follows. Initially, the UE is connected in the source cell with the serving DU.

Step 1. The CU initiates configuration of conditional reconfiguration for candidate target cell(s) controlled by the candidate DU and transmits a message, such as a UE CONTEXT SETUP REQUEST message, to the candidate DU. The message includes a request to configure L1/L2 inter-cell mobility and a conditional indication.

Step 2. The candidate DU creates the conditional reconfiguration for L1/L2 based inter-cell mobility serving cell change for the L1/L2 inter-cell mobility candidate(s). The candidate DU also creates a lower layer command for L1/L2 based inter-cell mobility serving cell change for each candidate. That command may be provided with the conditional reconfiguration. The candidate DU returns the created information to the CU in a response message, such as a UE CONTEXT SETUP RESPONSE message.

Step 3. The CU requests the serving DU to prepare for conditional L1/L2 inter cell mobility for L1/L2 inter-cell mobility candidate(s) by transmitting a message, such as a UE CONTEXT MODIFICATION REQUEST message, to the serving DU.

Step 4. The serving DU creates a lower layer command L1/L2 based inter-cell mobility serving cell change for each candidate. The serving DU returns the created lower layer command to the CU in a response message, such as a UE CONTEXT MODIFICATION RESPONSE message.

Step 5. The CU transmits a message, such as a DL RRC MESSAGE TRANSFER message, to the serving DU, containing the conditional reconfiguration(s) including the lower layer command(s), for example within an RRCReconfiguration message

Step 6. The serving DU transmits an RRCReconfiguration message containing the conditional configuration(s) per L1/L2 mobility candidate, including the lower layer command(s).

Step 7. The UE stores the received conditional reconfiguration(s) per L1/L2 mobility candidate and returns an RRCReconfigurationComplete message to the serving DU.

Step 8. The serving DU forwards the received RRCReconfigurationComplete message to the CU in an UL RRC MESSAGE TRANSFER message.

Step 9. The UE evaluates the execution condition(s) for the L1/L2 inter-cell mobility candidate(s). When an execution condition is fulfilled, the UE selects the candidate target cell and executes the conditional reconfiguration for this candidate. In this example, the UE applies the previously received lower layer command for L1/L2 based inter-cell mobility serving cell change for the selected target candidate, which results in the UE selecting candidate target cell and/or beam or TCI state in the candidate target cell.

Step 10. The UE transmits an UL message, such as a lower layer (L1 or MAC) signal or message to the candidate DU in the selected candidate target cell.

Step 11. The candidate DU transmits an indication of successful conditional L1/L2 inter-cell mobility to the CU.

Step 12. The CU transmits an indication of successful conditional L1/L2 inter-cell mobility to the serving DU.

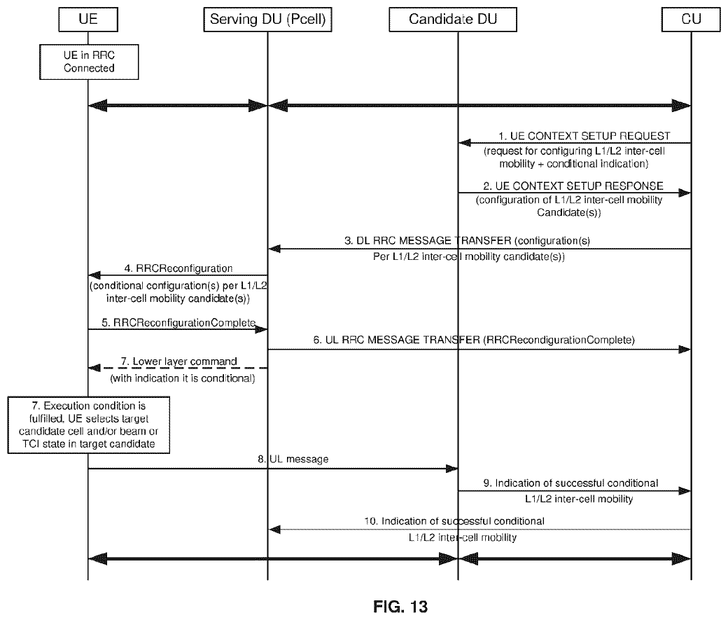

FIG. 13 illustrates another aspect of the disclosure in a distributed CU/DU RAN architecture. The UE is configured a conditional reconfiguration for L1/L2 based inter-cell mobility and the serving DU generates a lower layer command that is executed upon fulfilment of the condition, and this command is provided to the UE via lower layer, with an indication it is conditional.

Referring to FIG. 13, the main steps in this example are as follows. Initially, the UE is connected in the source cell with the serving DU.

Step 1. The CU initiates configuration of conditional reconfiguration for candidate target cell(s) controlled by the candidate DU and transmits a message, such as a UE CONTEXT SETUP REQUEST message, to the candidate DU. The message includes a request to configure L1/L2 inter-cell mobility and a conditional indication.

Step 2. The candidate DU creates the conditional reconfiguration for L1/L2 based inter-cell mobility serving cell change for the L1/L2 inter-cell mobility candidate(s). The candidate DU returns the created information to the CU in a response message, such as a UE CONTEXT SETUP RESPONSE message.

Step 3. The CU transmits a message, such as a DL RRC MESSAGE TRANSFER message, to the serving DU, containing the conditional reconfiguration(s) including the lower layer command(s), for example within an RRCReconfiguration message

Step 4. The serving DU transmits, to the UE, an RRCReconfiguration message containing the conditional configuration(s) per L1/L2 mobility candidate.

Step 5. The UE stores the received conditional reconfiguration(s) per L1/L2 mobility candidate and returns an RRCReconfigurationComplete message to the serving DU.

Step 6. The serving DU forwards the received RRCReconfigurationComplete message to the CU in an UL RRC MESSAGE TRANSFER message.

Step 7. The serving DU transmits a lower layer command for L1/L2 based inter-cell mobility serving cell change, for each L1/L2 mobility candidate, with an indication that it is conditional. UE stores each command and associates it with the conditional reconfiguration for the corresponding L1/L2 mobility candidate.

Step 8. The UE evaluates the execution condition(s) for the L1/L2 inter-cell mobility candidate(s). When an execution condition is fulfilled, the UE selects the candidate target cell and executes the conditional reconfiguration for this candidate. In this example, the UE applies the previously received lower layer command for L1/L2 based inter-cell mobility serving cell change for the selected target candidate, which results in the UE selecting candidate target cell and/or beam or TCI state in the candidate target cell.

Step 9. The UE transmits an UL message, sch as a lower layer (L1 or MAC) signal or message to the candidate DU in the selected candidate target cell.

Step 10. The candidate DU transmits an indication of successful conditional L1/L2 inter-cell mobility to the CU.

Step 11. The CU transmits an indication of successful conditional L1/L2 inter-cell mobility to the serving DU.

### 3GPP Technical Specification Implementation

The example below shows one representative implementation of aspects of the present disclosure in the RRC specification, 3GPP TS 38.331 v17.1.0. In this example, additions to 3GPP TS 38.331 v17.1.0 are marked with underline. In this example, an information element CondL12ReconfigToAddModList is defined, which is used to configure a list of conditional configuration(s) per L1/L2 mobility candidate, including an execution condition, an indication of a candidate target cell for L1/L2 mobility in the form of a Cell Group Configuration, and a lower layer command. The information element CondL12ReconfigToAddModList may for example be added as an optional field in the RRCReconfiguration message.

### CondL12ReconfigToAddModList

The IE CondL12ReconfigToAddModList concerns a list of conditional reconfigurations to add or modify, with for each entry the condReconfigID and the associated condExecustionCond/condExecutionCondSCG and condRRCReconfig, CondL12ReconfigToAddModList information element

-- ASN1START
-- TAG-CONDL12RECONFIGTOADDMODLIST-START

| | |
|---|---|
| CondL12ReconfigToAddModList-r18 ::= | SEQUENCE (SIZE (1.. |

maxNrofCondL12Cells-r18)) OF CondL12ReconfigToAddMod-r18

| | |
|---|---|
| CondL12ReconfigToAddMod-r18 ::= | SEQUENCE { |

| condL12ReconfigId-r18 | | CondReconfigId-r18, |
|---|---|---|
| condL12ExecutionCond-r18 | | SEQUENCE (SIZE (1..2)) OF |
| MeasId | OPTIONAL, | -- Need M |
| condL12CellGroupConfig-r18 | | OCTET STRING (CONTAINING |
| CellGroupConfig) | OPTIONAL, | -- Cond condL12ReconfigAdd |

| | |
|---|---|
| condL12MobilityCommand-r18 | OCTET STRING |

...
}
TAG-CONDL12RECONFIGTOADDMODLIST-STOP
ASN1STOP

CondReconfigToAddMod field descriptions

condL12ExecutionCond
The execution condition that needs to be fulfilled in order to trigger
the execution of a conditional reconfiguration for L1/L2 mobility.
condL12CellGroupConfig
The Cell Group Configuration to be switched to when the condition(s) are
fulfilled.
condL12MobilityCommand
Contains the MAC CE layer L1/L2 mobility command to be applied when
the condition(s) are fulfilled.

| Conditional Presence | Explanation |
|---|---|
| condL12ReconfigAdd | The field is mandatory present when a |
| | condL12ReconfigId is being added. Otherwise the |
| | field is optional, need M. |

### Network Description and Over the Top (OTT) Embodiments

FIG. 14 shows an example of a communication system QQ100 in accordance with some embodiments.

In the example, the communication system QQ100 includes a telecommunication network QQ102 that includes an access network QQ104, such as a radio access network (RAN), and a core network QQ106, which includes one or more core network nodes QQ108. The access network QQ104 includes one or more access network nodes, such as network nodes QQ110a and QQ110b (one or more of which may be generally referred to as network nodes QQ110), or any other similar 3rd Generation Partnership Project (3GPP) access node or non-3GPP access point. The network nodes QQ110 facilitate direct or indirect connection of user equipment (UE), such as by connecting UEs QQ112a, QQ112b, QQ112c, and QQ112d (one or more of which may be generally referred to as UEs QQ112) to the core network QQ106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system QQ100 may include any number of wired or wireless networks, network nodes, UEs, and/or any other components or systems that may facilitate or participate in the communication of data and/or signals whether via wired or wireless connections. The communication system QQ100 may include and/or interface with any type of communication, telecommunication, data, cellular, radio network, and/or other similar type of system.

The UEs QQ112 may be any of a wide variety of communication devices, including wireless devices arranged, configured, and/or operable to communicate wirelessly with the network nodes QQ110 and other communication devices. Similarly, the network nodes QQ110 are arranged, capable, configured, and/or operable to communicate directly or indirectly with the UEs QQ112 and/or with other network nodes or equipment in the telecommunication network QQ102 to enable and/or provide network access, such as wireless network access, and/or to perform other functions, such as administration in the telecommunication network QQ102.

In the depicted example, the core network QQ106 connects the network nodes QQ110 to one or more hosts, such as host QQ116. These connections may be direct or indirect via one or more intermediary networks or devices. In other examples, network nodes may be directly coupled to hosts. The core network QQ106 includes one more core network nodes (e.g., core network node QQ108) that are structured with hardware and software components. Features of these components may be substantially similar to those described with respect to the UEs, network nodes, and/or hosts, such that the descriptions thereof are generally applicable to the corresponding components of the core network node QQ108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host QQ116 may be under the ownership or control of a service provider other than an operator or provider of the access network QQ104 and/or the telecommunication network QQ102, and may be operated by the service provider or on behalf of the service provider. The host QQ116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system QQ100 of FIG. 14 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network QQ102 is a cellular network that implements 3GPP standardized features. Accordingly, the telecommunications network QQ102 may support network slicing to provide different logical networks to different devices that are connected to the telecommunication network QQ102. For example, the telecommunications network QQ102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs QQ112 are configured to transmit and/or receive information without direct human interaction. For instance, a UE may be designed to transmit information to the access network QQ104 on a predetermined schedule, when triggered by an internal or external event, or in response to requests from the access network QQ104. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub QQ114 communicates with the access network QQ104 to facilitate indirect communication between one or more UEs (e.g., UE QQ112c and/or QQ112d) and network nodes (e.g., network node QQ110b). In some examples, the hub QQ114 may be a controller, router, content source and analytics, or any of the other communication devices described herein regarding UEs. For example, the hub QQ114 may be a broadband router enabling access to the core network QQ106 for the UEs. As another example, the hub QQ114 may be a controller that sends commands or instructions to one or more actuators in the UEs. Commands or instructions may be received from the UEs, network nodes QQ110, or by executable code, script, process, or other instructions in the hub QQ114. As another example, the hub QQ114 may be a data collector that acts as temporary storage for UE data and, in some embodiments, may perform analysis or other processing of the data. As another example, the hub QQ114 may be a content source. For example, for a UE that is a VR headset, display, loudspeaker or other media delivery device, the hub QQ114 may retrieve VR assets, video, audio, or other media or data related to sensory information via a network node, which the hub QQ114 then provides to the UE either directly, after performing local processing, and/or after adding additional local content. In still another example, the hub QQ114 acts as a proxy server or orchestrator for the UEs, in particular in if one or more of the UEs are low energy IoT devices.

The hub QQ114 may have a constant/persistent or intermittent connection to the network node QQ110b. The hub QQ114 may also allow for a different communication scheme and/or schedule between the hub QQ114 and UEs (e.g., UE QQ112c and/or QQ112d), and between the hub QQ114 and the core network QQ106. In other examples, the hub QQ114 is connected to the core network QQ106 and/or one or more UEs via a wired connection. Moreover, the hub QQ114 may be configured to connect to an M2M service provider over the access network QQ104 and/or to another UE over a direct connection. In some scenarios, UEs may establish a wireless connection with the network nodes QQ110 while still connected via the hub QQ114 via a wired or wireless connection. In some embodiments, the hub QQ114 may be a dedicated hub—that is, a hub whose primary function is to route communications to/from the UEs from/to the network node QQ110b. In other embodiments, the hub QQ114 may be a non-dedicated hub—that is, a device which is capable of operating to route communications between the UEs and network node QQ110b, but which is additionally capable of operating as a communication start and/or end point for certain data channels.

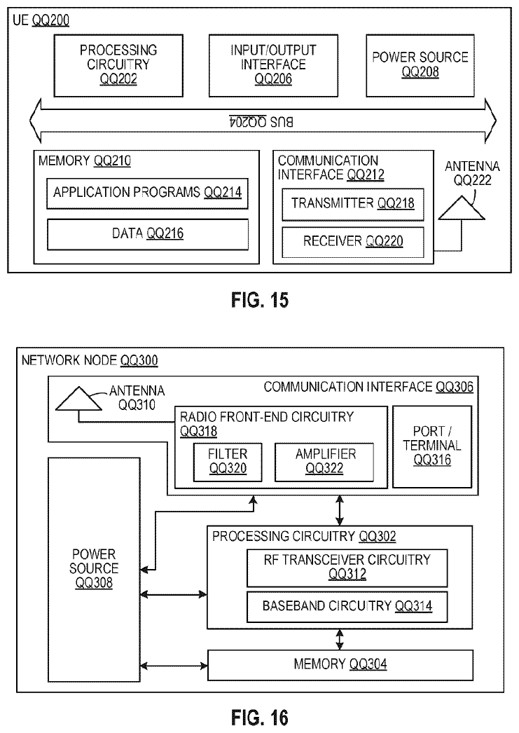

FIG. 15 shows a UE QQ200 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE QQ200 includes processing circuitry QQ202 that is operatively coupled via a bus QQ204 to an input/output interface QQ206, a power source QQ208, a memory QQ210, a communication interface QQ212, and/or any other component, or any combination thereof. Certain UEs may utilize all or a subset of the components shown in FIG. 15. The level of integration between the components may vary from one UE to another UE. Further, certain UEs may contain multiple instances of a component, such as multiple processors, memories, transceivers, transmitters, receivers, etc.

The processing circuitry QQ202 is configured to process instructions and data and may be configured to implement any sequential state machine operative to execute instructions stored as machine-readable computer programs in the memory QQ210. The processing circuitry QQ202 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry QQ202 may include multiple central processing units (CPUs).

In the example, the input/output interface QQ206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE QQ200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source QQ208 is structured as a battery or battery pack. Other types of power sources, such as an external power source (e.g., an electricity outlet), photovoltaic device, or power cell, may be used. The power source QQ208 may further include power circuitry for delivering power from the power source QQ208 itself, and/or an external power source, to the various parts of the UE QQ200 via input circuitry or an interface such as an electrical power cable. Delivering power may be, for example, for charging of the power source QQ208. Power circuitry may perform any formatting, converting, or other modification to the power from the power source QQ208 to make the power suitable for the respective components of the UE QQ200 to which power is supplied.

The memory QQ210 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory QQ210 includes one or more application programs QQ214, such as an operating system, web browser application, a widget, gadget engine, or other application, and corresponding data QQ216. The memory QQ210 may store, for use by the UE QQ200, any of a variety of various operating systems or combinations of operating systems.

The memory QQ210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory QQ210 may allow the UE QQ200 to access instructions, application programs and the like, stored on transitory or non-transitory memory media, to off-load data, or to upload data. An article of manufacture, such as one utilizing a communication system may be tangibly embodied as or in the memory QQ210, which may be or comprise a device-readable storage medium.

The processing circuitry QQ202 may be configured to communicate with an access network or other network using the communication interface QQ212. The communication interface QQ212 may comprise one or more communication subsystems and may include or be communicatively coupled to an antenna QQ222. The communication interface QQ212 may include one or more transceivers used to communicate, such as by communicating with one or more remote transceivers of another device capable of wireless communication (e.g., another UE or a network node in an access network). Each transceiver may include a transmitter QQ218 and/or a receiver QQ220 appropriate to provide network communications (e.g., optical, electrical, frequency allocations, and so forth). Moreover, the transmitter QQ218 and receiver QQ220 may be coupled to one or more antennas (e.g., antenna QQ222) and may share circuit components, software, or firmware, or alternatively be implemented separately.

In the illustrated embodiment, communication functions of the communication interface QQ212 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface QQ212, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected, an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE QQ200 shown in FIG. 15.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 16 shows a network node QQ300 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node QQ300 includes a processing circuitry QQ302, a memory QQ304, a communication interface QQ306, and a power source QQ308. The network node QQ300 may be composed of multiple physically separate components (e.g., a NodeB component and a RNC component, or a BTS component and a BSC component, etc.), which may each have their own respective components. In certain scenarios in which the network node QQ300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node QQ300 may be configured to support multiple radio access technologies (RATs). In such embodiments, some components may be duplicated (e.g., separate memory QQ304 for different RATs) and some components may be reused (e.g., a same antenna QQ310 may be shared by different RATs). The network node QQ300 may also include multiple sets of the various illustrated components for different wireless technologies integrated into network node QQ300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node QQ300.

The processing circuitry QQ302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node QQ300 components, such as the memory QQ304, to provide network node QQ300 functionality.

In some embodiments, the processing circuitry QQ302 includes a system on a chip (SOC). In some embodiments, the processing circuitry QQ302 includes one or more of radio frequency (RF) transceiver circuitry QQ312 and baseband processing circuitry QQ314. In some embodiments, the radio frequency (RF) transceiver circuitry QQ312 and the baseband processing circuitry QQ314 may be on separate chips (or sets of chips), boards, or units, such as radio units and digital units. In alternative embodiments, part or all of RF transceiver circuitry QQ312 and baseband processing circuitry QQ314 may be on the same chip or set of chips, boards, or units.

The memory QQ304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry QQ302. The memory QQ304 may store any suitable instructions, data, or information, including a computer program, software, an application including one or more of logic, rules, code, tables, and/or other instructions capable of being executed by the processing circuitry QQ302 and utilized by the network node QQ300. The memory QQ304 may be used to store any calculations made by the processing circuitry QQ302 and/or any data received via the communication interface QQ306. In some embodiments, the processing circuitry QQ302 and memory QQ304 is integrated.

The communication interface QQ306 is used in wired or wireless communication of signaling and/or data between a network node, access network, and/or UE. As illustrated, the communication interface QQ306 comprises port(s)/terminal(s) QQ316 to send and receive data, for example to and from a network over a wired connection. The communication interface QQ306 also includes radio front-end circuitry QQ318 that may be coupled to, or in certain embodiments a part of, the antenna QQ310. Radio front-end circuitry QQ318 comprises filters QQ320 and amplifiers QQ322. The radio front-end circuitry QQ318 may be connected to an antenna QQ310 and processing circuitry QQ302. The radio front-end circuitry may be configured to condition signals communicated between antenna QQ310 and processing circuitry QQ302. The radio front-end circuitry QQ318 may receive digital data that is to be sent out to other network nodes or UEs via a wireless connection. The radio front-end circuitry QQ318 may convert the digital data into a radio signal having the appropriate channel and bandwidth parameters using a combination of filters QQ320 and/or amplifiers QQ322. The radio signal may then be transmitted via the antenna QQ310. Similarly, when receiving data, the antenna QQ310 may collect radio signals which are then converted into digital data by the radio front-end circuitry QQ318. The digital data may be passed to the processing circuitry QQ302. In other embodiments, the communication interface may comprise different components and/or different combinations of components.

In certain alternative embodiments, the network node QQ300 does not include separate radio front-end circuitry QQ318, instead, the processing circuitry QQ302 includes radio front-end circuitry and is connected to the antenna QQ310. Similarly, in some embodiments, all or some of the RF transceiver circuitry QQ312 is part of the communication interface QQ306. In still other embodiments, the communication interface QQ306 includes one or more ports or terminals QQ316, the radio front-end circuitry QQ318, and the RF transceiver circuitry QQ312, as part of a radio unit (not shown), and the communication interface QQ306 communicates with the baseband processing circuitry QQ314, which is part of a digital unit (not shown).

The antenna QQ310 may include one or more antennas, or antenna arrays, configured to send and/or receive wireless signals. The antenna QQ310 may be coupled to the radio front-end circuitry QQ318 and may be any type of antenna capable of transmitting and receiving data and/or signals wirelessly. In certain embodiments, the antenna QQ310 is separate from the network node QQ300 and connectable to the network node QQ300 through an interface or port.

The antenna QQ310, communication interface QQ306, and/or the processing circuitry QQ302 may be configured to perform any receiving operations and/or certain obtaining operations described herein as being performed by the network node. Any information, data and/or signals may be received from a UE, another network node and/or any other network equipment. Similarly, the antenna QQ310, the communication interface QQ306, and/or the processing circuitry QQ302 may be configured to perform any transmitting operations described herein as being performed by the network node. Any information, data and/or signals may be transmitted to a UE, another network node and/or any other network equipment.

The power source QQ308 provides power to the various components of network node QQ300 in a form suitable for the respective components (e.g., at a voltage and current level needed for each respective component). The power source QQ308 may further comprise, or be coupled to, power management circuitry to supply the components of the network node QQ300 with power for performing the functionality described herein. For example, the network node QQ300 may be connectable to an external power source (e.g., the power grid, an electricity outlet) via an input circuitry or interface such as an electrical cable, whereby the external power source supplies power to power circuitry of the power source QQ308. As a further example, the power source QQ308 may comprise a source of power in the form of a battery or battery pack which is connected to, or integrated in, power circuitry. The battery may provide backup power should the external power source fail.

Embodiments of the network node QQ300 may include additional components beyond those shown in FIG. 16 for providing certain aspects of the network node's functionality, including any of the functionality described herein and/or any functionality necessary to support the subject matter described herein. For example, the network node QQ300 may include user interface equipment to allow input of information into the network node QQ300 and to allow output of information from the network node QQ300. This may allow a user to perform diagnostic, maintenance, repair, and other administrative functions for the network node QQ300.

FIG. 17 is a block diagram of a host QQ400, which may be an embodiment of the host QQ116 of FIG. 14, in accordance with various aspects described herein. As used herein, the host QQ400 may be or comprise various combinations hardware and/or software, including a standalone server, a blade server, a cloud-implemented server, a distributed server, a virtual machine, container, or processing resources in a server farm. The host QQ400 may provide one or more services to one or more UEs.

The host QQ400 includes processing circuitry QQ402 that is operatively coupled via a bus QQ404 to an input/output interface QQ406, a network interface QQ408, a power source QQ410, and a memory QQ412. Other components may be included in other embodiments. Features of these components may be substantially similar to those described with respect to the devices of previous figures, such as Figures QQ2 and QQ3, such that the descriptions thereof are generally applicable to the corresponding components of host QQ400.

The memory QQ412 may include one or more computer programs including one or more host application programs QQ414 and data QQ416, which may include user data, e.g., data generated by a UE for the host QQ400 or data generated by the host QQ400 for a UE.

Embodiments of the host QQ400 may utilize only a subset or all of the components shown. The host application programs QQ414 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC. Advanced Audio Coding (AAC), MPEG, G.711), including transcoding for multiple different classes, types, or implementations of UEs (e.g., handsets, desktop computers, wearable display systems, heads-up display systems). The host application programs QQ414 may also provide for user authentication and licensing checks and may periodically report health, routes, and content availability to a central node, such as a device in or on the edge of a core network. Accordingly, the host QQ400 may select and/or indicate a different host for over-the-top services for a UE. The host application programs QQ414 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

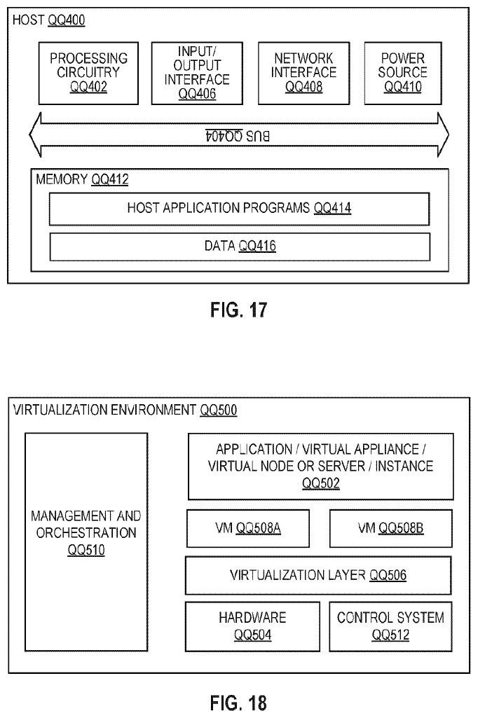

FIG. 18 is a block diagram illustrating a virtualization environment QQ500 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments QQ500 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications QQ502 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware QQ504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers QQ506 (also referred to as hypervisors or virtual machine monitors (VMMs)), provide VMs QQ508a and QQ508b (one or more of which may be generally referred to as VMs QQ508), and/or perform any of the functions, features and/or benefits described in relation with some embodiments described herein. The virtualization layer QQ506 may present a virtual operating platform that appears like networking hardware to the VMs QQ508.

The VMs QQ508 comprise virtual processing, virtual memory, virtual networking or interface and virtual storage, and may be run by a corresponding virtualization layer QQ506. Different embodiments of the instance of a virtual appliance QQ502 may be implemented on one or more of VMs QQ508, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM QQ508 may be a software implementation of a physical machine that runs programs as if they were executing on a physical, non-virtualized machine. Each of the VMs QQ508, and that part of hardware QQ504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs QQ508 on top of the hardware QQ504 and corresponds to the application QQ502.

Hardware QQ504 may be implemented in a standalone network node with generic or specific components. Hardware QQ504 may implement some functions via virtualization. Alternatively, hardware QQ504 may be part of a larger cluster of hardware (e.g. such as in a data center or CPE) where many hardware nodes work together and are managed via management and orchestration QQ510, which, among others, oversees lifecycle management of applications QQ502. In some embodiments, hardware QQ504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system QQ512 which may alternatively be used for communication between hardware nodes and radio units.

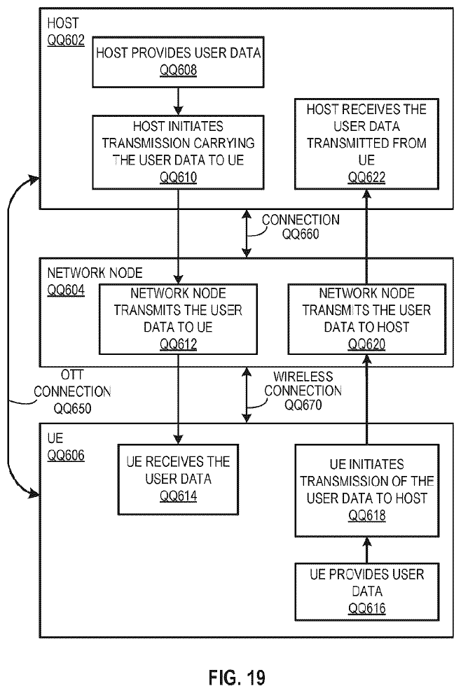

FIG. 19 shows a communication diagram of a host QQ602 communicating via a network node QQ604 with a UE QQ606 over a partially wireless connection in accordance with some embodiments. Example implementations, in accordance with various embodiments, of the UE (such as a UE QQ112a of FIG. 14 and/or UE QQ200 of FIG. 15), network node (such as network node QQ110a of FIG. 14 and/or network node QQ300 of FIG. 16), and host (such as host QQ116 of FIG. 14 and/or host QQ400 of FIG. 17) discussed in the preceding paragraphs will now be described with reference to FIG. 19.

Like host QQ400, embodiments of host QQ602 include hardware, such as a communication interface, processing circuitry, and memory. The host QQ602 also includes software, which is stored in or accessible by the host QQ602 and executable by the processing circuitry. The software includes a host application that may be operable to provide a service to a remote user, such as the UE QQ606 connecting via an over-the-top (OTT) connection QQ650 extending between the UE QQ606 and host QQ602. In providing the service to the remote user, a host application may provide user data which is transmitted using the OTT connection QQ650.

The network node QQ604 includes hardware enabling it to communicate with the host QQ602 and UE QQ606. The connection QQ660 may be direct or pass through a core network (like core network QQ106 of FIG. 14) and/or one or more other intermediate networks, such as one or more public, private, or hosted networks. For example, an intermediate network may be a backbone network or the Internet.

The UE QQ606 includes hardware and software, which is stored in or accessible by UE QQ606 and executable by the UE's processing circuitry. The software includes a client application, such as a web browser or operator-specific “app” that may be operable to provide a service to a human or non-human user via UE QQ606 with the support of the host QQ602. In the host QQ602, an executing host application may communicate with the executing client application via the OTT connection QQ650 terminating at the UE QQ606 and host QQ602. In providing the service to the user, the UE's client application may receive request data from the host's host application and provide user data in response to the request data. The OTT connection QQ650 may transfer both the request data and the user data. The UE's client application may interact with the user to generate the user data that it provides to the host application through the OTT connection QQ650.

The OTT connection QQ650 may extend via a connection QQ660 between the host QQ602 and the network node QQ604 and via a wireless connection QQ670 between the network node QQ604 and the UE QQ606 to provide the connection between the host QQ602 and the UE QQ606. The connection QQ660 and wireless connection QQ670, over which the OTT connection QQ650 may be provided, have been drawn abstractly to illustrate the communication between the host QQ602 and the UE QQ606 via the network node QQ604, without explicit reference to any intermediary devices and the precise routing of messages via these devices.

As an example of transmitting data via the OTT connection QQ650, in step QQ608, the host QQ602 provides user data, which may be performed by executing a host application. In some embodiments, the user data is associated with a particular human user interacting with the UE QQ606. In other embodiments, the user data is associated with a UE QQ606 that shares data with the host QQ602 without explicit human interaction. In step QQ610, the host QQ602 initiates a transmission carrying the user data towards the UE QQ606. The host QQ602 may initiate the transmission responsive to a request transmitted by the UE QQ606. The request may be caused by human interaction with the UE QQ606 or by operation of the client application executing on the UE QQ606. The transmission may pass via the network node QQ604, in accordance with the teachings of the embodiments described throughout this disclosure. Accordingly, in step QQ612, the network node QQ604 transmits to the UE QQ606 the user data that was carried in the transmission that the host QQ602 initiated, in accordance with the teachings of the embodiments described throughout this disclosure. In step QQ614, the UE QQ606 receives the user data carried in the transmission, which may be performed by a client application executed on the UE QQ606 associated with the host application executed by the host QQ602.

In some examples, the UE QQ606 executes a client application which provides user data to the host QQ602. The user data may be provided in reaction or response to the data received from the host QQ602. Accordingly, in step QQ616, the UE QQ606 may provide user data, which may be performed by executing the client application. In providing the user data, the client application may further consider user input received from the user via an input/output interface of the UE QQ606. Regardless of the specific manner in which the user data was provided, the UE QQ606 initiates, in step QQ618, transmission of the user data towards the host QQ602 via the network node QQ604. In step QQ620, in accordance with the teachings of the embodiments described throughout this disclosure, the network node QQ604 receives user data from the UE QQ606 and initiates transmission of the received user data towards the host QQ602. In step QQ622, the host QQ602 receives the user data carried in the transmission initiated by the UE QQ606.

One or more of the various embodiments improve the performance of OTT services provided to the UE QQ606 using the OTT connection QQ650, in which the wireless connection QQ670 forms the last segment. More precisely, the teachings of these embodiments may improve the speed and reliability of inter-cell mobility serving cell change and thereby provide benefits such as increased reliability, reduction in dropped called, better responsiveness, and extended battery lifetime by avoiding the reestablishment of dropped calls.

In an example scenario, factory status information may be collected and analyzed by the host QQ602. As another example, the host QQ602 may process audio and video data which may have been retrieved from a UE for use in creating maps. As another example, the host QQ602 may collect and analyze real-time data to assist in controlling vehicle congestion (e.g., controlling traffic lights). As another example, the host QQ602 may store surveillance video uploaded by a UE. As another example, the host QQ602 may store or control access to media content such as video, audio, VR or AR which it can broadcast, multicast or unicast to UEs. As other examples, the host QQ602 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency, and other factors on which the one or more embodiments improve. There may further be an optional network functionality for reconfiguring the OTT connection QQ650 between the host QQ602 and UE QQ606, in response to variations in the measurement results. The measurement procedure and/or the network functionality for reconfiguring the OTT connection may be implemented in software and hardware of the host QQ602 and/or UE QQ606. In some embodiments, sensors (not shown) may be deployed in or in association with other devices through which the OTT connection QQ650 passes; the sensors may participate in the measurement procedure by supplying values of the monitored quantities exemplified above, or supplying values of other physical quantities from which software may compute or estimate the monitored quantities. The reconfiguring of the OTT connection QQ650 may include message format, retransmission settings, preferred routing etc.; the reconfiguring need not directly alter the operation of the network node QQ604. Such procedures and functionalities may be known and practiced in the art. In certain embodiments, measurements may involve proprietary UE signaling that facilitates measurements of throughput, propagation times, latency, and the like, by the host QQ602. The measurements may be implemented in that software causes messages to be transmitted, in particular empty or dummy messages, using the OTT connection QQ650 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

Aspects of the present invention provide numerous advantages over the prior art, and may also provide one or more of the following technical advantage(s). The conditional execution of L1/L2 based inter-cell mobility serving cell change enables the serving cell change to be executed more quickly, and with less signaling overhead, than RRC-based methods. Aspects of the present disclosure enable the L1/L2 based inter-cell mobility serving cell change to be triggered without relying on signaling messages, including lower-layer signaling, being sent at the time of the execution of L1/L2 based inter-cell mobility serving cell change. Instead, the information is sent to the UE in advance. This prevents the source cell connection being dropped, or a L1/L2 based inter-cell mobility serving cell change that is triggered too late, because of poor radio conditions. This is since poor radio conditions may cause a lower layer signaling message from the network, to order the UE to perform the L1/L2 based inter-cell mobility serving cell change, to be lost or delayed, or a measurement report from the UE to trigger the execution of the L1/L2 based inter-cell mobility serving cell change gets lost or delayed.

### REFERENCES

The following references are incorporated herein, in their entireties.
RP-221799, 3GPP work item description: Further NR mobility enhancements, MediaTek, 3GPP
TSG RAN Meeting #96, Budapest, Hungary, Jun. 6-9, 2022
3GPP TS 38.300 v17.1.0, NR and NG-RAN Overall Description; Stage 2
3GPP TS 38.331, v17.1.0, RRC protocol specification
3GPP TS 38.473, v17.1.0, F1 application protocol (F1AP)

### OTT Embodiments

### Group A Embodiments

The Group A embodiments include claims 1-37
200. The method of any of the Group A embodiments, further comprising:
   providing user data; and
   forwarding the user data to a host via the transmission to the network node.

### Group B Embodiments

The Group B embodiments include claims 75-89
201. The method of any of the previous embodiments, further comprising:
   obtaining user data; and
   forwarding the user data to a host or a user equipment.

### Group C Embodiments

202. A user equipment for performing a Layer 1 or Layer 2 (L1/L2) based inter-cell mobility serving cell change, comprising:
   processing circuitry configured to perform any of the steps of any of the Group A embodiments; and
   power supply circuitry configured to supply power to the processing circuitry.
203. A network node for managing a Layer 1 or Layer 2 (L1/L2) based inter-cell mobility serving cell change of a User Equipment (UE), the network node comprising:
   processing circuitry configured to perform any of the steps of any of the Group B embodiments;
   power supply circuitry configured to supply power to the processing circuitry.
204. A user equipment (UE) for performing a Layer 1 or Layer 2 (L1/L2) based inter-cell mobility serving cell change, the UE comprising:
   an antenna configured to send and receive wireless signals;
   radio front-end circuitry connected to the antenna and to processing circuitry, and configured to condition signals communicated between the antenna and the processing circuitry;
   the processing circuitry being configured to perform any of the steps of any of the Group A embodiments;
   an input interface connected to the processing circuitry and configured to allow input of information into the UE to be processed by the processing circuitry;
   an output interface connected to the processing circuitry and configured to output information from the UE that has been processed by the processing circuitry; and
   a battery connected to the processing circuitry and configured to supply power to the UE.
205. A host configured to operate in a communication system to provide an over-the-top (OTT) service, the host comprising:
   processing circuitry configured to provide user data; and
   a network interface configured to initiate transmission of the user data to a cellular network for transmission to a user equipment (UE),
   wherein the UE comprises a communication interface and processing circuitry, the communication interface and processing circuitry of the UE being configured to perform any of the steps of any of the Group A embodiments to receive the user data from the host.
206. The host of the previous embodiment, wherein the cellular network further includes a network node configured to communicate with the UE to transmit the user data to the UE from the host.
207. The host of the previous 2 embodiments, wherein:
   the processing circuitry of the host is configured to execute a host application, thereby providing the user data; and
   the host application is configured to interact with a client application executing on the UE, the client application being associated with the host application.
208. A method implemented by a host operating in a communication system that further includes a network node and a user equipment (UE), the method comprising:
   providing user data for the UE; and
   initiating a transmission carrying the user data to the UE via a cellular network comprising the network node, wherein the UE performs any of the operations of any of the Group A embodiments to receive the user data from the host.
209. The method of the previous embodiment, further comprising:
   at the host, executing a host application associated with a client application executing on the UE to receive the user data from the UE.
210. The method of the previous embodiment, further comprising:
   at the host, transmitting input data to the client application executing on the UE, the input data being provided by executing the host application,
   wherein the user data is provided by the client application in response to the input data from the host application.
211. A host configured to operate in a communication system to provide an over-the-top (OTT) service, the host comprising:
   processing circuitry configured to provide user data; and
   a network interface configured to initiate transmission of the user data to a cellular network for transmission to a user equipment (UE),
   wherein the UE comprises a communication interface and processing circuitry, the communication interface and processing circuitry of the UE being configured to perform any of the steps of any of the Group A embodiments to transmit the user data to the host.
212. The host of the previous embodiment, wherein the cellular network further includes a network node configured to communicate with the UE to transmit the user data from the UE to the host.
213. The host of the previous 2 embodiments, wherein:
   the processing circuitry of the host is configured to execute a host application, thereby providing the user data; and
   the host application is configured to interact with a client application executing on the UE, the client application being associated with the host application.
214. A method implemented by a host configured to operate in a communication system that further includes a network node and a user equipment (UE), the method comprising:
   at the host, receiving user data transmitted to the host via the network node by the UE, wherein the UE performs any of the steps of any of the Group A embodiments to transmit the user data to the host.
215. The method of the previous embodiment, further comprising:
   at the host, executing a host application associated with a client application executing on the UE to receive the user data from the UE.
216. The method of the previous embodiment, further comprising:
   at the host, transmitting input data to the client application executing on the UE, the input data being provided by executing the host application,
   wherein the user data is provided by the client application in response to the input data from the host application.
217. A host configured to operate in a communication system to provide an over-the-top (OTT) service, the host comprising:
   processing circuitry configured to provide user data; and
   a network interface configured to initiate transmission of the user data to a network node in a cellular network for transmission to a user equipment (UE), the network node having a communication interface and processing circuitry, the processing circuitry of the network node configured to perform any of the operations of any of the Group B embodiments to transmit the user data from the host to the UE.
218. The host of the previous embodiment, wherein:
   the processing circuitry of the host is configured to execute a host application that provides the user data; and
   the UE comprises processing circuitry configured to execute a client application associated with the host application to receive the transmission of user data from the host.
219. A method implemented in a host configured to operate in a communication system that further includes a network node and a user equipment (UE), the method comprising:
   providing user data for the UE; and
   initiating a transmission carrying the user data to the UE via a cellular network comprising the network node, wherein the network node performs any of the operations of any of the Group B embodiments to transmit the user data from the host to the UE.
220. The method of the previous embodiment, further comprising, at the network node, transmitting the user data provided by the host for the UE.
221. The method of any of the previous 2 embodiments, wherein the user data is provided at the host by executing a host application that interacts with a client application executing on the UE, the client application being associated with the host application.
222. A communication system configured to provide an over-the-top service, the communication system comprising:
   a host comprising:
   processing circuitry configured to provide user data for a user equipment (UE), the user data being associated with the over-the-top service; and a network interface configured to initiate transmission of the user data toward a cellular
   network node for transmission to the UE, the network node having a communication interface and processing circuitry, the processing circuitry of the network node configured to perform any of the operations of any of the Group B embodiments to transmit the user data from the host to the UE.
223. The communication system of the previous embodiment, further comprising:
   the network node; and/or
   the user equipment.
224. A host configured to operate in a communication system to provide an over-the-top (OTT) service, the host comprising:
   processing circuitry configured to initiate receipt of user data; and
   a network interface configured to receive the user data from a network node in a cellular network, the network node having a communication interface and processing circuitry, the processing circuitry of the network node configured to perform any of the operations of any of the Group B embodiments to receive the user data from a user equipment (UE) for the host.
225. The host of the previous 2 embodiments, wherein:
   the processing circuitry of the host is configured to execute a host application, thereby providing the user data; and
   the host application is configured to interact with a client application executing on the UE, the client application being associated with the host application.
226. The host of the any of the previous 2 embodiments, wherein the initiating receipt of the user data comprises requesting the user data.
227. A method implemented by a host configured to operate in a communication system that further includes a network node and a user equipment (UE), the method comprising: at the host, initiating receipt of user data from the UE, the user data originating from a transmission which the network node has received from the UE, wherein the network node performs any of the steps of any of the Group B embodiments to receive the user data from the UE for the host.
228. The method of the previous embodiment, further comprising at the network node, transmitting the received user data to the host.
229. A method, performed by a network node operative in a wireless communication network, of controlling a candidate target cell and becoming a serving node of a User Equipment (UE) by the execution of a Layer 1 or Layer 2 (L1/L2) based inter-cell mobility serving cell change of the UE from a source cell to the candidate target cell, based on the fulfillment of an execution condition, comprising:
   receiving, from the UE, uplink signaling resulting from an (L1/L2) based inter-cell mobility serving cell change of the UE from a source cell, based on the fulfillment of an execution condition.
230. The method of embodiment 82, wherein the uplink signaling comprises an uplink message.
231. The method of embodiment 82, wherein the uplink signaling comprises a random access preamble.
232. The method of embodiment 82 further comprising, prior to receiving the uplink signaling from the UE:
   transmitting, to the serving node, a conditional reconfiguration for L1/L2 based inter-cell mobility serving cell change, the conditional reconfiguration including at least one of an execution condition, an indication of a candidate target cell for L1/L2 mobility, and a lower layer command.
233. The method of embodiment 85 further comprising, prior to transmitting the conditional reconfiguration to the serving node:
   receiving, from the serving node, a request to generate the conditional reconfiguration for L1/L2 based inter-cell mobility serving cell change.
234. The method of embodiment 85 further comprising, prior to transmitting the conditional reconfiguration to the serving node:
   determining an execution condition upon which the UE should execute the L1/L2 based inter-cell mobility serving cell change; and
   including the execution condition in the conditional reconfiguration.
235. The method of embodiment 85 further comprising, prior to transmitting the conditional reconfiguration to the serving node:
   generating a lower layer command to be executed by the UE upon the UE's detection of an execution condition, the lower layer command configured to execute the L1/L2 based inter-cell mobility serving cell change; and
   including the execution condition in the conditional reconfiguration.
236. The method of embodiment 85 further comprising, prior to transmitting the conditional reconfiguration to the serving node:
   generating an indication of the candidate target cell; and
   including the indication of the candidate target cell in the conditional reconfiguration.

1-126. (canceled)

127. A method, performed by User Equipment (UE) operative in a wireless communication network, of performing a Layer 1 or Layer 2 (L1/L2) based inter-cell mobility serving cell change, comprising:
receiving, from a serving network node controlling a serving cell, a message containing at least one conditional reconfiguration for L1/L2 based inter-cell mobility serving cell change, each conditional reconfiguration including at least one of an execution condition, an indication of a candidate target cell for L1/L2 mobility, and a lower layer command;
monitoring network conditions;
upon detecting that a received execution condition is fulfilled, executing a conditional reconfiguration resulting in a L1/L2 based inter-cell mobility serving cell change to a candidate target cell.

128. The method of claim 127 wherein the message is a Radio Resource Control (RRC) message.

129. The method of claim 127 wherein the execution condition is related to a Radio Resource Management (RRM) measurement.

130. The method of claim 129 wherein the execution condition is that a measured signal strength of a candidate target cell becomes a predetermined offset better than the measured signal strength of the serving cell.

131. The method of claim 129 wherein the execution condition is that a measured signal strength of the serving cell becomes worse than a first predetermined threshold and a measured signal strength of a candidate target cell becomes better than a second predetermined threshold.

132. The method of claim 127 wherein the execution condition is related to an L1 measurement.

133. The method of claim 127 wherein the execution condition is related to a measurement on a reference signal transmitted on a spatially directed beam.

134. The method of claim 127 wherein the execution condition is related to a measurement on one or more reference signals (RS) each associated to an RS identifier.

135. The method of claim 127 wherein the conditional reconfiguration includes the execution condition and a lower layer command, the method further comprising:
prior to receiving the conditional reconfiguration, receiving, from the serving cell, one or more candidate target cells;
upon receiving the conditional reconfiguration, storing the lower layer command; and
wherein the lower layer command is a Media Access Control (MAC) Control Element (CE) received by the MAC and stored, wherein the MAC CE indicates that the command is only to be applied upon fulfillment of an associated execution condition; and
wherein the wireless device determines the execution condition associated to the lower layer command by determining that an execution condition is associated to a first candidate target cell and determining that the lower layer command is associated to the same first candidate target cell.

136. A wireless device operative in a wireless communication network, comprising:
communication circuitry configured to communicate with other network nodes; and
processing circuitry operatively connected to the communication circuitry and configured to
receive, from a serving network node controlling a serving cell, a message containing at least one conditional reconfiguration for Layer 1 or Layer 2 (L1/L2) based inter-cell mobility serving cell change, each conditional reconfiguration including at least one of an execution condition, an indication of a candidate target cell for L1/L2 mobility, and a lower layer command;
monitor network conditions;
upon detecting that a received execution condition is fulfilled, execute a conditional reconfiguration resulting in a L1/L2 based inter-cell mobility serving cell change to a candidate target cell.

137. A method, performed by a serving network node operative in a wireless communication network, of controlling the execution of a Layer 1 or Layer 2 (L1/L2) based inter-cell mobility serving cell change of a wireless device from a source cell to a candidate target cell operative in the wireless communication network, based on the fulfillment of an execution condition, comprising:
transmitting, to the wireless device, a message containing at least one conditional reconfiguration for L1/L2 based inter-cell mobility serving cell change, each conditional reconfiguration including at least one of an execution condition, an indication of a candidate target cell for L1/L2 mobility, and a lower layer command;
in response to the wireless device monitoring network conditions, and upon detecting that a received execution condition is fulfilled, executing a conditional reconfiguration resulting in a L1/L2 based inter-cell mobility serving cell change to a candidate target cell, receiving, from a network node, an indication of a successful conditional L1/L2 inter-cell mobility serving cell change for the wireless device.

138. A network node, configured as a serving network node operative in a wireless communication network, comprising:
communication circuitry configured to communicate with other network nodes; and
processing circuitry operatively connected to the communication circuitry and configured to
transmit, to the wireless device, a message containing at least one conditional reconfiguration for Layer 1 or Layer 2 (L1/L2) based inter-cell mobility serving cell change, each conditional reconfiguration including at least one of an execution condition, an indication of a candidate target cell for L1/L2 mobility, and a lower layer command;
in response to the wireless device monitoring network conditions, and upon detecting that a received execution condition is fulfilled, executing a conditional reconfiguration resulting in a L1/L2 based inter-cell mobility serving cell change to a candidate target cell, receive, from a network node, an indication of a successful conditional L1/L2 inter-cell mobility serving cell change for the wireless device.

139. A method, performed by a candidate target network node operative in a wireless communication network, of controlling the execution of a Layer 1 or Layer 2 (L1/L2) based inter-cell mobility serving cell change of a wireless device from a source cell to a candidate target cell operative in the wireless communication network, based on the fulfillment of an execution condition, comprising:
receiving, from a network node, a request to configure a context for the wireless device for L1/L2 inter-cell mobility, the request including a conditional indication; and
in response to the wireless device monitoring network conditions, and upon detecting that a received execution condition is fulfilled, executing a conditional reconfiguration resulting in a L1/L2 based inter-cell mobility serving cell change to a candidate target cell, and receiving, from the wireless device, an uplink message.
